(19) United States
(12) Patent Application Publication
(10) Pub. No.: US 2026/0236810 A1
(43) Pub. Date: Aug. 13, 2026

(54) METHOD AND SYSTEM FOR SOLVING DYNAMIC SECURITY SPACE OF DISTRIBUTION NETWORKS AGGREGATED BY VIRTUAL POWER PLANTS

(71) Applicant: SOUTHEAST UNIVERSITY, Nanjing (CN)

(72) Inventors: Meng SONG, Nanjing (CN); Zekai XU, Nanjing (CN); Ciwei GAO, Nanjing (CN); Qinran HU, Nanjing (CN)

(21) Appl. No.: 19/532,526

(22) Filed: Feb. 6, 2026

Related U.S. Application Data
(63) Continuation of application No. PCT/CN2025/106823, filed on Jul. 3, 2025.

(30) Foreign Application Priority Data
Feb. 12, 2025 (CN) 202510153748.3

(51) Int. Cl. G06N 7/02; G06N 5/01; H02J 13/12

(52) U.S. Cl. CPC G06N 7/02; G06N 5/01; H02J 13/12

(57) ABSTRACT

A method for solving dynamic security space of distribution networks (DNs) aggregated by virtual power plants (VPPs) includes the steps of: acquiring DN topology information and calculating a hyperplane-characterized security region (SR) of a DN; acquiring fuzzy resource boundaries uploaded by a VPP, performing optimal decision-making calculations, and generating a fuzzy model of DN resources; inputting the fuzzy model of DN resources into the hyperplane-characterized SR of the DN to output a fuzzy dynamic security space of the DN, performing type reduction and defuzzification on the fuzzy dynamic security space of the DN to obtain a dynamic security space of the DN; inputting the dynamic security space of the DN into a pre-established VPP aggregation model to output a VPP aggregation capacity; and calculating a VPP congestion capacity caused by the dynamic security space of the DN in combination with an original VPP aggregation capacity.

### CROSS-REFERENCE TO RELATED APPLICATIONS

This application is a continuation of PCT/CN2025/106823, filed on Jul. 3, 2025 and claims priority of Chinese Patent Application No. 202510153748.3, filed on Feb. 12, 2025, the entire contents of which are incorporated herein by reference.

### TECHNICAL FIELD

The present disclosure relates to the technical field of safe operation of distribution networks (DNs), and particularly to a method and system for solving dynamic security space of DNs aggregated by virtual power plants (VPPs).

### BACKGROUND

Driven by the dual-carbon policy, more and more renewable energy sources are connected to the power system, which poses great challenges to the balance between supply and demand in the power system. Various distributed resources on the user side (such as distributed energy storage, electric vehicles and air conditioners) provide adjustable flexibility to solve this problem. However, under the background of numerous types and quantities of distributed resources, dispersed geographical locations, and small adjustable scale, VPPs have become an effective way to manage distributed resources and serve the power grid.

Since distributed resources are located at different nodes in the DN, all distributed resources comply with grid power flow safety constraints such as voltage stability limits and thermal stability limits. For VPPs that manage many distributed resources, power flow safety constraints are observed in the process of aggregating and controlling distributed resources. This further strengthens the operational relationship between the VPP and the DN. However, DN operation security constraints are the privacy and exclusive data of DN operators. It is necessary to solve the problem of safe operation of DN in the process of managing distributed resources in VPPs.

### SUMMARY

An objective of the present disclosure is to provide a method and system for solving dynamic security space of the DNs aggregated by VPPs to solve the shortcomings mentioned in the above background.

According to the first aspect, the objective of the present disclosure can be achieved by the following technical solutions: a method for solving dynamic security space of DNs aggregated by VPPs includes the steps of:
acquiring DN topology information and calculating a hyperplane-characterized security region (SR) of a DN based on the DN topology information; and acquiring fuzzy resource boundaries uploaded by a VPP, performing optimal decision-making calculations based on the fuzzy resource boundaries, and establishing a fuzzy model of DN resources using optimal decision values;
inputting the fuzzy model of DN resources into the hyperplane-characterized SR of the DN to output a fuzzy dynamic security space of the DN; and performing type reduction and defuzzification on the fuzzy dynamic security space of the DN by an improved enhanced opposite direction search algorithm to obtain a dynamic security space of the DN; and
inputting the dynamic security space of the DN into a pre-established VPP aggregation model to output a VPP aggregation capacity; and calculating a VPP congestion capacity caused by the dynamic security space of the DN in combination with an original VPP aggregation capacity.

In combination with the first aspect, in some implementations of the first aspect, the method further includes the following steps: the SR of the DN describes power flow security constraints from the perspective of the region, the power flow security constraints include voltage constraint limits of all nodes and current constraint limits of all branches, and the SR of the DN with node injection power as a decision space is expressed by the following equations:

$${Ω}_{j}^{DVSR} = \{ {\sum }_{h = 1}^{n} {γ}_{j , h}^{U , M} {P}_{h} + {χ}_{j , h}^{U , M} {Q}_{h} \leq 1 , {\sum }_{h = 1}^{n} {γ}_{j , h}^{U , m} {P}_{h} + {χ}_{j , h}^{U , m} {Q}_{h} \leq 1 \} \qquad ( 1 )$$

$${Ω}_{i}^{DTSR} = \{ - 1 \leq {\sum }_{h = 1}^{n} {γ}_{i , h}^{I} {P}_{h} + {χ}_{i , h}^{I} {Q}_{h} \leq 1 \} \qquad ( 2 )$$

$${Ω}_{DSR} = {Ω}_{j}^{DVSR} ⋂ {Ω}_{i}^{DTSR} \qquad ( 3 )$$

where

$${Ω}_{i}^{DTSR}$$

represents a voltage SR of a node j;

$${γ}_{j , h}^{U , m} and {χ}_{j , h}^{U , m}$$

represent hyperplane coefficients of a node h in an upper voltage SR of the node j;

$${γ}_{j , h}^{U , m} and {χ}_{j , h}^{U , m}$$

represent Fhyperplane coefficients of the node h in the upper voltage SR of the node j; Pₕ and Qₕ represent an active and a reactive power injected by the node h;

$${Ω}_{i}^{DTSR}$$

represents a thermal stability SR of a line i;

$${γ}_{i , h}^{I} and {χ}_{i , h}^{I}$$

are hyperplane coefficients of the node h in the thermal stability SR of the line i; and Ω_{DSR} represents a hyperplane SR;
relevant hyperplane coefficients are corrected based on actual power flow operation results of DistFlow, and a compact form of the SR of the DN is given as follows:

$${\sum }_{j = 1}^{n} γ {P}_{j} + ϰ {Q}_{j} \leq 1 \qquad ( 4 )$$

where γ and χ represent the compact form of hyperplane coefficients; and Pⱼ and Qⱼ represent the compact form of node injection power.

In connection with the first aspect, in some implementations of the first aspect, the method further includes the following steps: set optimization objectives of the DN include the minimum global network loss and the minimum voltage deviation of the DN, and a multi-objective optimization problem M1 is set as follows, where objective functions are as follows:

$${min}_{{P}_{dso}} \{ λ {\sum }_{l = 1}^{L} ( {P}_{l , t}^{l o s s} ) + ( 1 - λ ) {\sum }_{i = 1}^{J} ( \vert Δ {U}_{i , t}^{c} \vert ) \} \qquad ( 5 )$$

$${\underline{P}}_{i}^{dso , vg} \leq {P}_{i , t}^{dso , vg} \leq {{\overline{P}}^{⌣}}_{i}^{dso , vg} \qquad ( 6 )$$

$${P}_{i , t}^{dso , vg} tan {\underline{φ}}_{i}^{dso , vg} \leq {Q}_{i , t}^{dso , vg} \leq {P}_{i , t}^{dso , vg} tan {\overline{φ}}_{i}^{dso , v g} \qquad ( 7 )$$

$$- {\overline{P}}_{i}^{dso , ve} \leq {P}_{i , t}^{dso , ve} \leq {\overline{P}}_{i}^{dso , ve} , {\underline{E}}_{i}^{dso , ve} \leq {E}_{i , t}^{dso , ve} \leq {\overline{E}}_{i}^{dso , ve} \qquad ( 8 )$$

$${E}_{i , t + 1}^{dso , ve} = {α}_{i}^{dso , ve} {E}_{i , t}^{dso , ve} + {β}_{i}^{dso , ve} {P}_{i , t}^{dso , ve} , {E}_{i , T}^{dso , ve} = {E}_{i , 0}^{dso , ve} \qquad ( 9 )$$

$${( {P}_{i , t}^{dso , ve} )}^{2} + {( {Q}_{i , t}^{cdso , ve} )}^{2} \leq {( {S}_{i}^{dso , ve} )}^{2} \qquad ( 10 )$$

$${P}_{i , t}^{vpp , f} , {Q}_{i , t}^{vpp , f} ∈ [ {\tilde{κ}}_{i , t}^{μ} , {\tilde{κ}}_{i , t}^{σ} ] ; {\tilde{κ}}_{i , t}^{μ} , {\tilde{κ}}_{i , t}^{σ} = 〈 a , b , c 〉 \qquad ( 11 )$$

$${P}_{i , t}^{nor} = {{P}^{⌣}}_{i , t}^{nor} , {Q}_{i , t}^{nor} = {{Q}^{⌣}}_{i , t}^{nor} \qquad ( 12 )$$

$${S}_{n} = F ( P , Q , U , I ) \qquad ( 13 )$$

where λ represents a multi-objective coefficient;

$${P}_{l , t}^{loss}$$

represents a network loss of a line l at a time t;

$$Δ {U}_{i , t}^{c}$$

represents a voltage deviation of the node i at the time t;

$${P}_{i , t}^{dso , vg} and {Q}_{i , t}^{dso , vg}$$

represent an active power and a reactive power of a virtual generator in N_{dso};

$${{\overline{P}}^{⌣}}_{i}^{dso , vg} and {\underline{P}}_{i}^{dso , vg}$$

represent upper and lower limits of the active power of the virtual generator in N_{dso};

$${\overline{φ}}_{i}^{dso , vg} and {\underline{φ}}_{i}^{dso , vg}$$

represent upper and lower limits of a power factor angle of the virtual generator in N_{dso};

$${P}_{i , t}^{dso , ve} and {Q}_{i , t}^{dso , ve}$$

represent an active power and a reactive power of virtual energy storage in N_{dso};

$${\overline{P}}_{i , t}^{dso , ve}$$

represents an active power limit of the virtual energy storage in N_{dso};

$${\overline{E}}_{i}^{dso , ve} and {\underline{E}}_{i}^{dso , ve}$$

represent energy limits of the virtual energy storage in N_{dso};

$${E}_{i , t}^{dso , ve}$$

represents an energy of the virtual energy storage in N_{dso};

$${S}_{i}^{dso , ve}$$

represents an apparent power limit of the virtual energy storage in N_{dso};

$${P}_{i , t}^{vpp , f} and {Q}_{i , t}^{vpp , f}$$

represent fuzzy output powers of all nodes provided by the VPP for Nᵥₚₚ;

$${\tilde{κ}}_{i , t}^{μ} and {\tilde{κ}}_{i , t}^{σ}$$

represent triangular fuzzy membership functions of upper and lower limits of the output power; α, b and c represent parameters of the triangular fuzzy membership functions;

$${P}_{i , t}^{nor} and {Q}_{i , t}^{nor}$$

represent an active power and a reactive power of Nₙₒᵣ; and Sₙ represents a power flow constraint; and
where (6)-(7) represent output constraints of the virtual generator in the nodes N_{dso} controlled by a DN operator; (8)-(9) represent output constraints of the virtual energy storage in N_{dso}; (11) represents fuzzy output boundary constraints of all node provided by the VPP for Nᵥₚₚ; (12) represents an output constraint of Nₙₒᵣ; (13) represents the DistFlow power flow constraint; and the optimization problem includes random variables

$${{P}^{⌣}}_{i , t}^{nor} and {{Q}^{⌣}}_{i , t}^{nor} ,$$

and fuzzy variables

$${\tilde{κ}}_{i , t}^{μ} and {\tilde{κ}}_{i , t}^{σ} .$$

In connection with the first aspect, in some implementations of the first aspect, the method further includes the follows steps: the performing optimal decision-making calculations based on the fuzzy resource boundaries includes the steps of:
solving the multi-objective optimization problem M1 according to a specific operation mode to obtain operation results of N_{dso}, and modeling the resource output of N_{dso} nodes using a fuzzy model;
regarding N_{dso} decision values

$${P}_{i , t}^{dso , vg , c} , {Q}_{i , t}^{dso , vg , c} , {P}_{i , t}^{dso , ve , c} and {Q}_{i , t}^{dso , vg , c}$$

obtained by solving the optimization problem M1, serving as the most probable operation results under a specific DN operation state, performing separate fuzzy modeling for the active power and reactive power in N_{dso} nodes:
firstly, modeling an active power

$${\tilde{P}}_{i}^{dso}$$

of the virtual generator using a type-I triangular fuzzy membership function:

$$μ ( {\tilde{P}}_{i}^{dso} ) = \{ \begin{matrix}( {\tilde{P}}_{i}^{dso} - {F}_{1 , i}^{P} ) / ( {F}_{2 , i}^{P} - {F}_{1 , i}^{P} ) , & {\tilde{P}}_{i}^{dso} ∈ ( {F}_{1 , i}^{p} , {F}_{2 , i}^{p} ] \\ ( {F}_{3 , i}^{P} - {\tilde{P}}_{i}^{dso} ) / ( {F}_{3 , i}^{P} - {F}_{2 , i}^{P} ) , & {\tilde{P}}_{i}^{dso} ∈ ( {F}_{2 , i}^{p} , {F}_{3 , i}^{p} ] \\ 0 , & other\end{matrix} \qquad ( 14 )$$

where

$${F}_{1 , i}^{p} , {F}_{2 , i}^{p} and {F}_{3 , i}^{p}$$

represent three parameters of the triangular fuzzy membership function; and
combining Equation (6) with the geometric relationship in FIG. 1, parameters of

$${\tilde{P}}_{i , t}^{dso , vg}$$

are sequentially expressed as

$${\underline{P}}_{i}^{dso , vg} , {P}_{i , t}^{dso , vg , c} and {{\overline{P}}^{⌣}}_{i}^{dso , vg} , ;$$

it is to be known from Equation (7) that a reactive power range of the virtual generator is directly related to the active power of the virtual generator; and since the active power of the virtual generator is characterized by the type-I triangular fuzzy membership function, a type-II triangular fuzzy membership function is used for the fuzzy modeling of the reactive power of the virtual generator, and the reactive power range characterized by Equation (7) and the fuzzy modeling of the active power of the virtual generator characterized by Equation (14) are integrated;
obtaining a main membership function of the type-II triangular fuzzy membership function for the reactive power of the virtual generator, and substituting the parameters, the following expression is obtained:

$$\begin{matrix}{\tilde{Q}}_{i , t}^{dso , v g} = 〈 [ {{\overline{P}}^{⌣}}_{i}^{dso , vg} tan {\underline{φ}}_{i}^{dso , vg} , {\underline{P}}_{i}^{dso , vg} tan {\underline{φ}}_{i}^{dso , vg} ] , \\ {Q}_{i , t ,}^{dso , v g , c} , [ {\underline{P}}_{i}^{dso , vg} tan {\overline{φ}}_{i}^{dso , vg} , {{\overline{P}}^{⌣}}_{i}^{dso , vg} tan {\overline{φ}}_{i}^{dso , vg} ] 〉\end{matrix} \qquad ( 15 )$$

where

$${Q}_{i , t}^{dso , vg , c}$$

represents a reactive output value based on optimal decision;
due to the parameter magnitude relationship of the type-II triangular fuzzy membership function, corrected parameters are given as:

$${{\overline{P}}^{⌣}}_{i}^{dso , vg} tan {\underline{φ}}_{i}^{dso , vg} , min ( {Q}_{i , t}^{dso , vg , c} , {\underline{P}}_{i}^{dso , vg} tan {\underline{φ}}_{i}^{dso , vg} ) , {Q}_{i , t}^{dso , vg , c} , max ( {Q}_{i , t}^{dso , vg , c} , {\underline{P}}_{i}^{dso , vg} tan {\overline{φ}}_{i}^{dso , vg} ) and {{\overline{P}}^{⌣}}_{i}^{dso , vg} tan {\overline{φ}}_{i}^{dso , vg} ;$$

the corresponding upper membership function

$${v}_{\tilde{Q}}^{dso , +}$$

and lower membership function

$${v}_{\tilde{Q}}^{dso , -}$$

are as follows:

$$\{ \begin{matrix}{v}_{\tilde{Q}}^{dso , +} = 〈 {{\overline{P}}^{⌣}}_{i}^{dso , vg} tan {\underline{φ}}_{i}^{dso , vg} , {Q}_{i , t}^{dso , vg , c} , {{\overline{P}}^{⌣}}_{i}^{dso , vg} tan {\overline{φ}}_{i}^{dso , vg} 〉 \\ {v}_{\tilde{Q}}^{dso , -} = 〈 \begin{matrix}min ( {Q}_{i , t}^{dso , c} , {\underline{P}}_{i}^{dso , vg} tan {\underline{φ}}_{i}^{dso , vg} ) \\ {Q}_{i , t}^{dso , vg , c} , max ( {Q}_{i , t}^{dso , c} , {\underline{P}}_{i}^{dso , vg} tan {\overline{φ}}_{i}^{dso , vg} )\end{matrix} 〉\end{matrix} \qquad ( 16 )$$

the left endpoint l corresponding to

$${Q}_{i , t}^{dso , vg}$$

is the type-I triangular fuzzy membership function, with parameters:

$$〈 {{\overline{P}}^{⌣}}_{i}^{dso , vg} tan {\underline{φ}}_{i}^{dso , vg} , min [ min ( {Q}_{i , t}^{dso , vg , c} , {\underline{P}}_{i}^{dso , vg} tan {\underline{φ}}_{i}^{dso , vg} ) , {P}_{i , t}^{dso , vg} tan {\underline{φ}}_{i}^{dso , vg} ] , min ( {Q}_{i , t}^{dso , c} , {\underline{P}}_{i}^{dso , vg} tan {\underline{φ}}_{i}^{dso , vg} 〉 \qquad ( 17 )$$

similarly, the corresponding right endpoint r has similar parameter characteristics, which are:

$$〈 max ( {Q}_{i , t}^{dso , vg , c} , {\underline{P}}_{i}^{dso , v g} tan {\overline{φ}}_{i}^{dso , vg} ) , max [ max ( {Q}_{i , t}^{dso , vg , c} , {\underline{P}}_{i}^{dso , v g} tan {\overline{φ}}_{i}^{dso , vg} ) , {P}_{i , t}^{dso , vg , c} tan {\overline{φ}}_{i}^{dso , vg} ] , {{\overline{P}}^{⌣}}_{i}^{dso , vg} tan {\overline{φ}}_{i}^{dso , vg} 〉 \qquad ( 18 )$$

through setting rules of the fuzzy system, the type-II triangular fuzzy membership function for the reactive power of the virtual generator is obtained;
for

$${Q}_{i , t}^{dso , ve} ,$$

it is known from Equation (10) that

$${P}_{i , t}^{dso , ve}$$

is different from

$${P}_{i , t}^{dso , vg} ,$$

when modeling

$${Q}_{i , t}^{dso , ve} ,$$

a fuzzy model of virtual energy storage is established through the method of first establishing the type-I triangular fuzzy membership function for

$${P}_{i , t}^{dso , ve}$$

and establishing the type-II triangular fuzzy membership function for

$${Q}_{i , t}^{dso , ve} ,$$

following a completely opposite order, since

$${E}_{i , t}^{dso , ve}$$

is directly determined by

$${P}_{i , t}^{dso , ve} ,$$

and for the unification of

$${Q}_{i , t}^{dso , vg}$$

modeling format,

$${P}_{i , t}^{dso , ve}$$

is determined as a basic model of the type-I triangular fuzzy membership function;
the parameter values of

$${\tilde{P}}_{i , t}^{dso , ve}$$

are sequentially

$$min ( {\overline{P}}_{i}^{dso , ve} \cdot sign ( {P}_{i , t}^{dso , ve , c} ) , 0 ) , {P}_{i , t}^{dso , ve , c} and max ( {\overline{P}}_{i}^{dso , ve} \cdot sign ( {P}_{i , t}^{dso , ve , c} ) , 0 ) ;$$

the same method as that for the virtual generator is adopted for the fuzzy modeling of

$${Q}_{i , t}^{dso , ve} ,$$

the type-II triangular fuzzy membership function is

$${\tilde{Q}}_{i , t}^{dso , ve} = 〈 [ {\underline{l}}^{ve , q} , {\overline{l}}^{ve , q} ] , {c}^{ve , q} , [ {\underline{r}}^{ve , q} , {\overline{r}}^{ve , q} ] 〉 ,$$

and Equation (10) and N_{dso} decisions

$${Q}_{i , t}^{dso , ve , c}$$

are substituted into the main membership function as follows:

$$〈 [ - {\overline{Q}}_{i , t}^{dso , ve} , min ( {Q}_{i , t}^{dso , ve , c} , 0 ) ] , {Q}_{i , t}^{dso , ve , c} , [ max ( {Q}_{i , t}^{dso , ve , c} , 0 ) , {\overline{Q}}_{i , t}^{dso , ve} ] 〉 \qquad ( 19 )$$

the corresponding upper membership function

$${v}_{\tilde{Q}}^{vpp , +}$$

and lower membership function

$${v}_{\tilde{Q}}^{vpp , -}$$

are as follows:

$$\{ \begin{matrix}{v}_{\tilde{Q}}^{vpp , +} = 〈 - {\overline{Q}}_{i , t}^{dso , ve} , - {Q}_{i , t}^{dso , ve , c} , {\overline{Q}}_{i , t}^{dso , ve} 〉 \\ {v}_{\tilde{Q}}^{vpp , -} = 〈 min ( {Q}_{i , t}^{dso , ve , c} , 0 ) , {Q}_{i , t}^{dso , ve , c} , max ( {Q}_{i , t}^{dso , ve , c} , 0 ) 〉\end{matrix} \qquad ( 20 )$$

membership functions of l and r are as follows:

$$\{ \text{} \begin{matrix}l = 〈 - {\overline{Q}}_{i , t}^{dso , ve} , - {Q}_{i , t}^{dso , P , c} , min ( {Q}_{i , t}^{dso , ve , c} , 0 ) 〉 \\ r = 〈 max ( {Q}_{i , t}^{dso , ve , c} , 0 ) , {Q}_{i , t}^{dso , P , c} , {\overline{Q}}_{i , t}^{dso , ve} 〉\end{matrix} \text{} \qquad ( 21 )$$

where

$${Q}_{i , t}^{dso , P , c} = \sqrt{{( {S}_{i}^{dso , we} )}^{2} - {( {P}_{i , t}^{dso , ve , c} )}^{2}} ,$$

the complete fuzzy modeling of N_{dso} is obtained; combined with the modeling of Nₙₒᵣ, the fuzzy form of the dynamic security space of the DN is obtained as follows:

$${\sum }_{j = 1}^{n} γ {\tilde{P}}_{j} + 𝒳 {\tilde{Q}}_{j} \leq 1 \qquad ( 22 )$$

Equation (22) including fuzzy and random factors is expressed in the form of a credibility chance constraint as follows:

$$Ch \{ {\sum }_{j = 1}^{n} γ {P}_{j} + {𝒳Q}_{j} \leq 1 \} \geq α \qquad ( 23 )$$

where Ch represents a chance measure, and α represents a credibility;
for the random factors in N_{dso} and Nₙₒᵣ, derandomization is performed through the probability confidence level, and Equation (23) is equivalent to:

$$Cr \{ w ∈ Ω \vert Pr \{ {\sum }_{j = 1}^{n} γ {P}_{j} + {𝒳Q}_{j} \leq 1 \} \geq {α}^{*} \} \geq α \qquad ( 24 )$$

where Cr represents a credibility measure, Pr represents a probability measure, and α* represents a confidence level;
it is converted into:

$$Cr \{ ( {P}^{⌣} , {Q}^{⌣} ) = {C}_{DF , dso , nor}^{- 1} ( {α}^{*} ) \vert {\sum }_{j = 1}^{n} γ {P}_{j} + {𝒳Q}_{j} \leq 1 \} \geq α \qquad ( 25 )$$

where

$${C}_{DF , dso , nor}^{- 1}$$

represents an inverse function of a cumulative distribution function.

Through the deterministic conversion of random variables characterizing output and parameters within the model, a fuzzy chance constraint model of the dynamic security space of the DN including the type-I triangular fuzzy membership function and type-II triangular fuzzy membership function is established.

In combination with the first aspect, in some implementations of the first aspect, the method further includes the following steps: the performing type reduction on the fuzzy dynamic security space of the DN by an improved enhanced opposite direction search algorithm includes the steps of: for the type-II triangular fuzzy membership function in the dynamic security space of the DN, the left endpoint

$${C}_{α}^{L}$$

of the centroid set of the α-plane of the type-II triangular fuzzy membership function is defined, sampling points qₗ_{_{α}} of the α-plane where l_{α}∈{k|1≤k≤N} are inevitably present such that

$${q}_{{l}_{α}} \leq {C}_{α}^{L} \leq {q}_{{l}_{α} + 1} ,$$

and the following equation is obtained by further combining equations (16) and (20):

$$\{ \text{} \begin{matrix}{\sum }_{i = 1}^{{l}_{α} - 1} ( {q}_{{l}_{α}} - {q}_{i} ) \cdot {v}_{\tilde{Q}}^{+} ( {q}_{i} \vert α ) \leq {\sum }_{i = {l}_{α} + 1}^{N} ( {q}_{i} - {q}_{{l}_{α}} ) \cdot {v}_{\tilde{Q}}^{-} ( {q}_{i} \vert α ) \\ {\sum }_{i = 1}^{{l}_{α}} ( {q}_{{l}_{α} + 1} - {q}_{i} ) \cdot {v}_{\tilde{Q}}^{+} ( {q}_{i} \vert α ) \leq {\sum }_{i = {l}_{α} + 2}^{N} ( {q}_{i} - {q}_{{l}_{α} + 1} ) \cdot {v}_{\tilde{Q}}^{-} ( {q}_{i} \vert α )\end{matrix} \text{} \qquad ( 26 )$$

a function

$${h}_{\tilde{Q}}^{α}$$

is defined as follows:

$${h}_{\tilde{Q}}^{α} ( k ) = {\sum }_{i = k + 1}^{N} ( {q}_{i} - {q}_{k} ) \cdot {v}_{\tilde{Q}}^{-} ( {q}_{i} \vert α ) - {\sum }_{i = 1}^{k - 1} ( {q}_{k} - {q}_{i} ) \cdot {v}_{\tilde{Q}}^{+} ( {q}_{i} \vert α ) \qquad ( 27 )$$

the vertical difference v_{\tilde{Q}}⁺(qᵢ|α)−v_{\tilde{Q}}⁻(qᵢ|α) between the upper membership function v_{\tilde{Q}}⁺ and the lower membership function v_{\tilde{Q}}⁻ on the α-plane is designated as v_{\tilde{Q}}(qᵢ|α), and is simultaneously defined as:

$${l}_{q , α} = {\sum }_{i = 1}^{N} {q}_{i} \cdot {v}_{\tilde{Q}}^{-} ( {q}_{i} \vert α ) , {l}_{α} = {\sum }_{i = 1}^{N} {v}_{\tilde{Q}}^{-} ( {q}_{i} \vert α ) \qquad ( 28 )$$

Equation (27) is expressed as:

$${h}_{\tilde{Q}}^{α} ( k ) = {l}_{q , α} - {q}_{k} {l}_{α} = {\sum }_{i = 1}^{k - 1} ( {q}_{k} - {q}_{i} ) \cdot {v}_{\tilde{Q}} ( {q}_{i} \vert α ) \qquad ( 29 )$$

by defining

$${δ}_{α} ( k ) = {l}_{α} + {\sum }_{i}^{k} {v}_{\tilde{Q}} ( {q}_{i} \vert α ) ,$$

the iterative equation is obtained as:

$${h}_{\tilde{Q}}^{α} ( k + 1 ) - {h}_{\tilde{Q}}^{α} ( k ) = ( {q}_{k} - {q}_{k + 1} ) {δ}_{α} ( k ) < 0 \qquad ( 30 )$$

the termination condition is to obtain the conversion point, based on the critical magnitude relationship of the conversion point, the termination condition is satisfied as follows:

$$\{ {h}_{\tilde{Q}}^{α} ( k ) < 0 \} and \{ {h}_{\tilde{Q}}^{α} ( k + 1 ) \geq 0 \} \qquad ( 31 )$$

at this point k=l_{α}, the left endpoint

$${C}_{α}^{L}$$

is derived as:

$${C}_{α}^{L} = {q}_{{l}_{α}} + {h}_{\tilde{Q}}^{α} ( {l}_{α} ) / {δ}_{P , α} ( {l}_{α} + 1 ) \qquad ( 32 )$$

by adopting the same approach, the right endpoint

$${C}_{α}^{R}$$

is expressed as when k=r_{α}:

$${C}_{α}^{R} = {q}_{{l}_{α}} + {h}_{\tilde{Q}}^{α} ( {r}_{α} ) / {δ}_{Q , α} ( {r}_{α} ) \qquad ( 33 )$$

due to the unique correspondence between qᵢ and v_{\tilde{Q}}⁺(qᵢ|α) and v_{\tilde{Q}}⁻(qᵢ|α) of the type-II triangular fuzzy membership function, when α:0→1,

$${C}_{α}^{R} ↑ and {C}_{α}^{L} ↓ ,$$

the conversion from the type-II triangular fuzzy membership function to the type-I triangular fuzzy membership function is achieved by utilizing the improved enhanced opposite direction search algorithm based on the characteristics of the type-II triangular fuzzy membership function.

In combination with the first aspect, in some implementations of the first aspect, the method further includes the following steps: the performing defuzzification on the fuzzy dynamic security space of the DN includes the steps of:
after converting the type-II triangular fuzzy membership function of the dynamic security space of the DN into the type-I triangular fuzzy membership function by means of the improved enhanced opposite direction search algorithm, the unified form of all power fuzzy membership functions for virtual generators and virtual energy storage is given as follows:

$${ℒ}^{L , R} = {ℒ}^{L} ( {C}_{α}^{L} , {α}^{L} ) , {ℒ}^{R} ( {C}_{α}^{R} , {α}^{R} ) \qquad ( 34 )$$

[symbol] ^{L,R} represents a piecewise fuzzy membership function included by

$${ℒ}^{L} ( {C}_{α}^{L} , {α}^{L} ) and {ℒ}^{R} ( {C}_{α}^{R} , {α}^{R} ) , {ℒ}^{L} ( {C}_{α}^{L} , {α}^{L} ) and {ℒ}^{R} ( {C}_{α}^{R} , {α}^{R} )$$

represent piecewise fuzzy membership functions formed by the left endpoint, right endpoint and corresponding α under each α, each segment of the fuzzy membership function is abbreviated as [symbol] (C(α)), and the further clarification equivalence of the dynamic security space of the DN characterized by Equation (23) is performed;
N_{dso} is separated from the dynamic security space of the DN, and Equation (23) is transformed into:

$$Cr \{ {\sum }_{j = 1}^{{J}_{dso}} γ {P}_{j}^{dso} + {\sum }_{j = 1}^{{J}_{dso}} χ {Q}_{j}^{dso} \leq K \} \geq ℘ \qquad ( 35 )$$

$$K = 1 - {\sum }_{j = 1}^{{J}_{nor}} ( γ {\hat{P}}_{j}^{nor} + χ {\hat{Q}}_{j}^{nor} ) + {\sum }_{j = 1}^{{J}_{dso}} ( γ {P}_{j}^{vpp} + χ {Q}_{j}^{vpp} ) \qquad ( 36 )$$

where

$${P}_{j}^{dso} and {Q}_{j}^{dso}$$

represent compact forms of N_{dso}-controlled resources;

$${\hat{P}}_{j}^{nor} and {\hat{Q}}_{j}^{nor}$$

represent compact forms of Nₙₒᵣ-controlled resources;

$${P}_{j}^{vpp} and {Q}_{j}^{vpp}$$

represent compact forms of Nᵥₚₚ-controlled resources; and [symbol] represents the credibility;
the least common divisor interval of the multi-segment linear membership function in Equation (34) is characterized as ( [symbol] ᵢ, [symbol] ᵢ+Δ [symbol] ], and within this interval, the credibility chance constraint is expressed as:

$$Cr \{ {\sum }_{j = 1}^{2 {J}_{dso}} {ϖ}_{i , j}^{s} {𝒥}_{j} \leq κ \} \geq ℘ , s ∈ \{ P , Q \} \qquad ( 37 )$$

where ℑⱼ represents a node power of N_{dso};

$${ϖ}_{i , j}^{s}$$

represents a hyperplane coefficient γ corresponding to the node j or a line ij (either or χ); and Equation (37) is transformed into:

$$Cr \{ \text{?} \leq κ \} = 0.5 ( 1 + \text{?} ( x ) - \text{?} ( x ) ) = 0.5 ( 1 + 1 - \text{?} ( x ) ) \qquad ( 38 )$$

the following equivalent conversion of Cr{ℑ≤κ}≥ [symbol] is achieved:

$$Cr \{ \text{?} \leq κ \} \geq ℘ ⇒ \text{?} ( x ) \leq 2 - 2 ℘ \qquad ( 39 )$$

for [symbol] ∈(0,1], and ℑₛᵤₚ( [symbol] )|sup{κ|sup_{x>k}μ_{ℑ}(x) [symbol] }, there is ℑₛᵤₚ(2−2 [symbol] )≤κ;
by further combining Equation (37), the following equation is obtained:

$${\text{?}}_{sup} ( 2 - 2 ℘ ) = {( {\sum }_{j = 1}^{2 {J}_{dso}} {\overline{ω}}_{i , j}^{s} {\text{?}}_{j} )}_{sup} ( 2 - 2 ℘ ) = {\sum }_{j = 1}^{2 n} {\overline{ω}}_{i , j}^{s} {\text{?}}_{j} ( 2 - 2 ℘ ) \leq κ \qquad ( 40 )$$

if [symbol] ∈((2− [symbol] ᵢ)/2, (2−( [symbol] ᵢ+Δ [symbol] ))/2], for each I, there is:

$${ℒ}_{x} ( {C}^{R} ( {℘}_{i} ) ) = 2 - 2 ℘ \qquad ( 41 )$$

$${\text{?}}_{sup} ( 2 - 2 ℘ ) = {ℒ}_{x}^{- 1} ( 2 - 2 ℘ )$$

is obtained by combining Equation (40), where

$${ℒ}_{x}^{- 1} ( 2 - 2 ℘ )$$

is a solution of Equation (41);
when [symbol] ∈(0.5,1]∩((2− [symbol] ᵢ)/2, (2−( [symbol] ᵢ+Δ [symbol] ))/2], Equation (37) is transformed into:

$${\sum }_{j = 1}^{{J}_{dso}} {ℒ}_{R , x , s , i}^{- 1} ( 2 - 2 ℘ ) \leq κ , ∀ i ∈ {N}_{d} , s ∈ \{ P , Q \} \qquad ( 42 )$$

in the same way, when [symbol] ∈(0,0.5]·( [symbol] ᵢ/2, ( [symbol] ᵢ+Δ [symbol] )/2], there is:

$${\sum }_{j = 1}^{{J}_{dso}} {ℒ}_{R , x , s , i}^{- 1} ( 2 ℘ ) \leq κ , ∀ i ∈ {N}_{d} , s ∈ \{ P , Q \} \qquad ( 43 )$$

the fuzzy dynamic security space of the DN is defuzzified.

In connection with the first aspect, in some implementations of the first aspect, the method further includes the following steps: the pre-established VPP aggregation model is as follows:

$${[ e q ( 6 ) - e q ( 10 ) ]}_{vpp} \qquad ( 44 )$$

$$[ {P}_{i , t}^{vpp} , {Q}_{i , t}^{vpp} ] ∈ {Ω}_{dsor} \qquad ( 45 )$$

$${P}_{t}^{vpp} = {\sum }_{i = 1}^{N} {P}_{i , t}^{vpp} , {Q}_{t}^{vpp} = {\sum }_{i = 1}^{N} {Q}_{i , t}^{vpp} \qquad ( 46 )$$

where [eq(6)−eq(10)]ᵥₚₚ, represents the resource model of the VPP obtained by changing subscripts in Equations (6) to (10) to “vpp”;

$${P}_{i , t}^{vpp} and {Q}_{i , t}^{vpp}$$

represent the active power and reactive power of the resources in the VPP; Ω_{dsor} represents the dynamic security space of the DN; and

$${P}_{t}^{vpp} and {Q}_{t}^{vpp}$$

represent the active power and reactive power of the VPP.

All constraints in the VPP aggregation model are linear constraints, and all faces of the high-dimensional space polyhedron characterized by the VPP aggregation model are planes; and the vertices of the operation region projection of the VPP are solved by an optimization problem, and the optimization problem M2 is as follows:

$${max}_{P , Q} {μ}_{h} \cdot {[ {P}_{h , t}^{vfrp} , {Q}_{h , t}^{vfrp} ]}^{T} \qquad ( 47 )$$

$$s . t . eq ( 64 ) - ( 65 ) , {Q}_{t}^{vfrp} = {P}_{t}^{vfrp} tan {φ}_{h} \qquad ( 48 )$$

where the direction vector μₕ is [cos φₕ, sin φₕ], φₕ∈[0,2π];

$${P}_{t}^{vfrp} and {Q}_{t}^{vfrp}$$

represent the active power and reactive power within the projection plane;
a calculation equation of the congestion capacity Yₜ of the VPP is as follows:

$${Υ}_{t} = {ω}_{1} \frac{1}{{N}_{h}} {\sum }_{i = 1}^{{N}_{h}} \sqrt{\frac{{( {P}_{h , t}^{or} - {P}_{h , t}^{vfrp} )}^{2} + {( {Q}_{h , t}^{or} - {Q}_{h , t}^{vfrp} )}^{2}}{{( {P}_{h , t}^{or} )}^{2} - {( {Q}_{h , t}^{or} )}^{2}}} + ( 1 - {ω}_{1} ) ( 1 - {Θ}_{t}^{vfrp} / {Θ}_{t}^{or} ) \qquad ( 49 )$$

where ω₁ represents an adjustment coefficient;

$${P}_{h , i}^{or} and {Q}_{h , i}^{or}$$

represent power operating points without considering the dynamic security space of the DN; and

$${Θ}_{t}^{vfrp} and {Θ}_{t}^{or}$$

represent projection areas considering and without considering the dynamic security space of the DN;
a day-ahead VPP congestion capacity is comprehensively evaluated by the maximum congestion [symbol] ^{max} and average congestion [symbol] ^{are}:

$${\text{?}}^{a v e} = ( {\sum }_{t = 1}^{T} {\text{?}}_{t} ) / T , {\text{?}}^{max} = {max}_{t ∈ [ 1 , T ]} ( {\text{?}}_{t} ) . \qquad ( 50 )$$

In a second aspect, the present disclosure provides a system for solving dynamic security space of the DN aggregated by VPPs to achieve the above objective, including:
a basic modeling module, configured to acquire DN topology information and calculate a hyperplane-characterized SR of a DN based on the DN topology information; and acquire fuzzy resource boundaries uploaded by a VPP, perform optimal decision-making calculations based on the fuzzy resource boundaries, and establish a fuzzy model of DN resources using optimal decision values;
a spatial solution module, configured to input the fuzzy model of DN resources into the hyperplane-characterized SR of the DN to output a fuzzy dynamic security space of the DN; and perform type reduction and defuzzification on the fuzzy dynamic security space of the DN by an improved enhanced opposite direction search algorithm to obtain a dynamic security space of the DN; and
a spatial analysis module, configured to input the dynamic security space of the DN into a pre-established VPP aggregation model to output a VPP aggregation capacity; and calculate a VPP congestion capacity caused by the dynamic security space of the DN in combination with an original VPP aggregation capacity.

In another aspect of the present disclosure, a terminal device is provided to achieve the above objective, including a memory, a processor, and a computer program stored in the memory and capable of running on the processor, the memory stores a computer program capable of running on the processor, and when the processor loads and executes the computer program, the method for solving dynamic security space of DNs aggregated by VPPs as described above is adopted.

In another aspect of the present disclosure, a computer-readable storage medium is provided to achieve the above objective, having a computer program stored therein, when the computer program is loaded and executed by a processor, the method for solving dynamic security space of DNs aggregated by VPPs as described above is adopted.

The present disclosure has the following advantageous effects.

The present disclosure provides a novel framework for coordinated operation of a VPP and a DN. Based on the dynamic security space of the DN calculated by the DN, the VPP achieves data privacy protection between the VPP and the DN with minimal data sharing, reducing the risk of power flow security violations in the distribution system.

A hybrid fuzzy modeling method for the dynamic security space of the DN based on the type-I triangular fuzzy membership function and the type-II triangular fuzzy membership function is adopted to characterize the security boundaries of distributed resources within the VPP. The dynamic security space of the DN only constrains the output power of distributed resources in the VPP, making the dynamic security space of the DN more applicable than SRs of traditional DNs. In addition, the dynamic security space of the DN considers the power flow coupling relationships between geographically dispersed distributed resources. Therefore, compared with the operating envelope, the dynamic security space of the DN can describe the aggregation capacity of the VPP in a more conservative manner.

To clarify the impact of DN operation safety risks on the aggregation capacity of VPPs, the improved enhanced opposite direction search algorithm is adopted for the fuzzy reduction of the dynamic security space of the DN. In addition, a piecewise membership function clarification method based on the generalized credibility theory is proposed to clarify the dynamic security space of the DN, which helps manage the power grid operation risks of VPPs when there are no direct restrictions from power flow operation constraints.

The concept of VPP congestion capacity proposed in the present disclosure quantifies the reduction in the aggregation capacity of VPPs due to the constraints of power system power flow, which helps to coordinate the safe and economic operation between VPPs and the DN.

### BRIEF DESCRIPTION OF THE DRAWINGS

To explain the technical solutions of examples in the present disclosure or in the prior art more clearly, the accompanying drawings required in the description of the examples or the prior art are introduced briefly below. Obviously, other drawings can be obtained according to these drawings without creative efforts for those ordinary skilled in the art.

FIG. 1 is a schematic flow diagram of a method of the present disclosure.

FIG. 2 is a schematic diagram of parameters of a virtual generator.

FIG. 3 is a schematic diagram of parameters of virtual energy storage.

FIG. 4 is a schematic diagram of parameterization of VPP congestion capacity.

FIG. 5 is a schematic diagram of projection of a VPP operating region under different confidence levels.

FIG. 6 is a schematic diagram of projection of the VPP operating region under different grid structure constraints.

FIG. 7 is a schematic diagram of the VPP congestion capacity under different model parameters.

FIG. 8 is a schematic structural diagram of a system of the present disclosure.

### DETAILED DESCRIPTION

Technical solutions in the examples of the present disclosure will be described clearly and completely in the following with reference to the accompanying drawings in the examples of the present disclosure. Obviously, all the described examples are only some, rather than all examples of the present disclosure. Based on the examples in the present disclosure, all other examples obtained by those ordinary skilled in the art without creative efforts belong to the protection scope of the present disclosure.

### Example 1

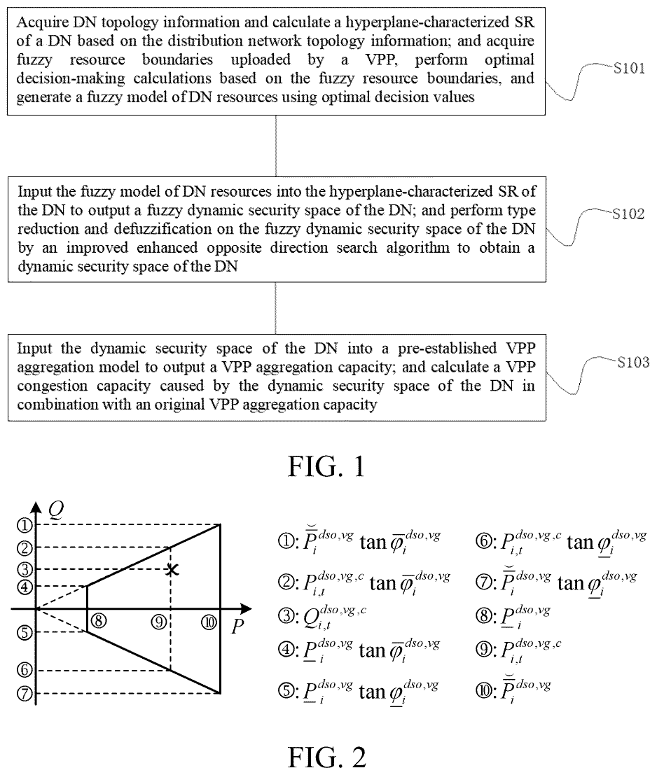

As shown in FIG. 1, a method and system for solving dynamic security space of the DN aggregated by VPPs, the method includes the following steps.

In S101: DN topology information is acquired, and a hyperplane-characterized SR of a DN is calculated based on the DN topology information; and fuzzy resource boundaries uploaded by a VPP are acquired, optimal decision-making calculations are performed based on the fuzzy resource boundaries uploaded by the VPP, and a fuzzy model of DN resources is established using optimal decision values.

The SR of the DN describes power flow security constraints from the perspective of the region. The power flow security constraints include voltage constraint limits of all nodes and current constraint limits of all branches. the SR of the DN with node injection power as a decision space is expressed by the following equations:

$${Ω}_{j}^{DVSR} = \{ {\sum }_{h = 1}^{n} {γ}_{j , h}^{U , M} {P}_{h} + {χ}_{j , h}^{U , M} {Q}_{h} \leq 1 , {\sum }_{h = 1}^{n} {γ}_{j , h}^{U , m} {P}_{h} + {χ}_{j , h}^{U , m} {Q}_{h} \leq 1 \} \qquad ( 1 )$$

$${Ω}_{i}^{DTSR} = \{ - 1 \leq {\sum }_{h = 1}^{n} {γ}_{i , h}^{I} {P}_{h} + {χ}_{i , h}^{I} {Q}_{h} \leq 1 \} \qquad ( 2 )$$

$${Ω}_{DSR} = {Ω}_{j}^{DVSR} ∩ {Ω}_{i}^{DTSR} \qquad ( 3 )$$

where

$${Ω}_{j}^{DVSR}$$

represents a voltage SR of a node j;

$${γ}_{j , h}^{U , M} and {χ}_{j , h}^{U , M}$$

represent hyperplane coefficients of a node h in an upper voltage SR of the node j;

$${γ}_{j , h}^{U , m} and {χ}_{j , h}^{U , m}$$

represent hyperplane coefficients of the node h in the upper voltage SR of the node j; Pₕ and Qₕ represent an active and a reactive power injected by the node h;

$${Ω}_{i}^{DTSR}$$

represents a thermal stability SR of a line i;

$${γ}_{i , h}^{I} and {χ}_{i , h}^{I}$$

are hyperplane coefficients of the node h in the thermal stability SR of the line i; and Ω_{DSR} represents a hyperplane SR.

Since hyperplane coefficients such as γ and χ are analytical results based on certain assumptions (e.g., power loss neglected), deviations exist between these coefficients and the actual security boundaries. In this paper, relevant hyperplane coefficients are corrected based on actual power flow operation results of DistFlow. A compact form of the SR of the DN is given as follows:

$${\sum }_{j = 1}^{n} γ {P}_{j} + χ {Q}_{j} \leq 1 \qquad ( 4 )$$

where γ and χ represent the compact form of hyperplane coefficients; and Pⱼ and Qⱼ represent the compact form of node injection power.

The dynamic security space of the DN can be understood as a hyperplane space derived from the evolution and dimensionality reduction of the SR of the DN, and its most prominent feature is that only Nᵥₚₚ (VPP controlled nodes) are taken as decision variables. Therefore, in the process of evolution and dimensionality reduction of the SR of the DN, the main difficulty lies in the real-numberization of all variables except Nᵥₚₚ. In the DN, different power grid operation modes lead to differences in power flow distribution. To maximize the regulation capacity of all nodes in the power grid, this paper takes the optimal power flow under specific operation modes of the DN as the starting point, and carries out real-numberization modeling for relevant nodes.

Set optimization objectives of the DN include the minimum global network loss and the minimum voltage deviation of the DN, and a multi-objective optimization problem M1 is set as follows, where objective functions are as follows:

$${min}_{{P}_{dso}} \{ λ {\sum }_{l = 1}^{L} ( {P}_{l , t}^{loss} ) + ( 1 - λ ) {\sum }_{i = 1}^{J} ( \vert Δ {U}_{i , t}^{c} \vert ) \} \qquad ( 5 )$$

$${\underline{P}}_{i}^{dso , vg} \leq {P}_{i , t}^{dso , vg} \leq {{\overline{{P}_{i}}}^{⌣}}^{dso , vg} \qquad ( 6 )$$

$${P}_{i , t}^{dso , vg} tan {\underline{φ}}_{i}^{dso , vg} \leq {Q}_{i , t}^{dso , vg} \leq {P}_{i , t}^{dso , vg} tan {\overline{φ}}_{i}^{dso , vg} \qquad ( 7 )$$

$$- {\overline{P}}_{i}^{dso , ve} \leq {P}_{i , t}^{dso , ve} \leq {\overline{P}}_{i}^{dso , ve} , {\underline{E}}_{i}^{dso , ve} \leq {E}_{i , t}^{dso , ve} \leq {\overline{E}}_{i}^{dso , ve} \qquad ( 8 )$$

$${E}_{i , t + 1}^{dso ,} = {α}_{i}^{dso , ve} {E}_{i , t}^{dso , ve} + {β}_{i}^{dso , ve} {P}_{i , t}^{dso , ve} , {E}_{i , T}^{dso , ve} = {E}_{i , 0}^{dso , ve} \qquad ( 9 )$$

$${( {P}_{i , t}^{dso , ve} )}^{2} + {( {Q}_{i , t}^{dso , ve} )}^{2} \leq {( {S}_{i}^{dso , ve} )}^{2} \qquad ( 10 )$$

$${P}_{i , t}^{vpp , f} , {Q}_{i , t}^{vpp , f} ∈ [ {\tilde{κ}}_{i , t}^{μ} , {\tilde{κ}}_{i , t}^{σ} ] ; {\tilde{κ}}_{i , t}^{μ} , {\tilde{κ}}_{i , t}^{σ} = 〈 a , b , c 〉 \qquad ( 11 )$$

$${P}_{i , t}^{nor} = {{P}^{⌣}}_{i , t}^{nor} , {Q}_{i , t}^{nor} = {{Q}^{⌣}}_{i , t}^{nor} \qquad ( 12 )$$

$${S}_{n} = F ( P , Q , U , I ) \qquad ( 13 )$$

where λ represents a multi-objective coefficient;

$${P}_{l , t}^{loss}$$

represents a network loss of a line l at a time t;

$$Δ {U}_{i , t}^{c}$$

represents a voltage deviation of the node i at the time t;

$${P}_{i , t}^{dso , vg} and {Q}_{i , t}^{dso , vg}$$

represent an active power and a reactive power of a virtual generator in N_{dso};

$${{\overline{{P}_{i}}}^{⌣}}^{dso , vg} and {\underline{P}}_{i}^{dso , vg}$$

represent upper and lower limits of the active power of the virtual generator in N_{dso};

$${\overline{φ}}_{i}^{dso , vg} and {\underline{φ}}_{i}^{dso , vg}$$

represent upper and lower limits of a power factor angle of the virtual generator in N_{dso};

$${P}_{i , t}^{dso , ve} and {Q}_{i , t}^{dso , ve}$$

represent an active power and a reactive power of virtual energy storage in N_{dso};

$${\overline{P}}_{i}^{dso , ve}$$

represents an active power limit of the virtual energy storage in N_{dso};

$${\overline{E}}_{i}^{dso , ve} and {\underline{E}}_{i}^{dso , ve}$$

represent energy limits of the virtual energy storage in N_{dso};

$${E}_{i , t}^{dso , ve}$$

represents an energy of the virtual energy storage in N_{dso};

$${S}_{i}^{dso , ve}$$

represents an apparent power limit of the virtual energy storage in N_{dso};

$${P}_{i , t}^{vpp , f} and {Q}_{i , t}^{vpp , f}$$

represent fuzzy output powers of all nodes provided by the VPP for Nᵥₚₚ;

$${\tilde{κ}}_{i , t}^{μ} and {\tilde{κ}}_{i , t}^{σ}$$

represent triangular fuzzy membership functions of upper and lower limits of the output power; α, b and c represent parameters of the triangular fuzzy membership functions;

$${P}_{i , t}^{nor} and {Q}_{i , t}^{nor}$$

represent an active power and a reactive power of Nₙₒᵣ; and Sₙ represents a power flow constraint; and
where (6)-(7) represent output constraints of the virtual generator in the nodes N_{dso} controlled by a DN operator; (8)-(9) represent output constraints of the virtual energy storage in N_{dso}; (11) represents fuzzy output boundary constraints of all node provided by the VPP for Nᵥₚₚ; (12) represents an output constraint of Nₙₒᵣ; (13) represents the DistFlow power flow constraint; and the optimization problem includes random variables

$${{P}^{⌣}}_{i , t}^{nor} and {{Q}^{⌣}}_{i , t}^{nor} ,$$

and fuzzy variables

$${\tilde{κ}}_{i , t}^{μ} and {\tilde{κ}}_{i , t}^{σ} .$$

In S102: the fuzzy model of DN resources is input into the hyperplane-characterized SR of the DN to output a fuzzy dynamic security space of the DN; and type reduction and defuzzification are performed on the fuzzy dynamic security space of the DN by an improved enhanced opposite direction search algorithm to obtain a dynamic security space of the DN.

Optimal decision-making calculations are performed based on the fuzzy resource boundaries uploaded by the VPP, specifically including the following steps.

The multi-objective optimization problem M1 is solved according to a specific operation mode to obtain operation results of N_{dso}, and the resource output of N_{dso} nodes is modeled using a fuzzy model.

Regarding the N_{dso} decision values

$${P}_{i , t}^{dso , vg , c} , {Q}_{i , t}^{dso , vg , c} , {P}_{i , t}^{dso , ve , c} and {Q}_{i , t}^{dso , vg , c}$$

obtained by solving the optimization problem M1, which are served as the most probable operation results under a specific DN operation state, separate fuzzy modeling is performed for the active power and reactive power in N_{dso} nodes:
firstly, the active power

$${\tilde{P}}_{i}^{dso}$$

of the virtual generator is modeled using a type-I triangular fuzzy membership function:

$$μ ( {\tilde{P}}_{i}^{dso} ) = \{ \text{} \begin{matrix}{\tilde{( P}}_{i}^{dso} - {F}_{1 , i}^{P} ) / ( {F}_{2 , i}^{P} - {F}_{1 , i}^{P} ) , & {\tilde{P}}_{i}^{dso} ∈ ( {F}_{1 , i}^{p} , {F}_{2 , i}^{p} ] \\ ( {F}_{3 , i}^{P} - {\tilde{P}}_{i}^{dso} ) / ( {F}_{3 , i}^{P} - {F}_{2 , i}^{P} ) , & {\tilde{P}}_{i}^{dso} ∈ ( {F}_{2 , i}^{p} , {F}_{3 , i}^{p} ] \\ 0 , & other\end{matrix} \text{} \qquad ( 14 )$$

where

$${F}_{1 , i}^{p} , {F}_{2 , i}^{p} and {F}_{3 , i}^{p}$$

represent three parameters of the triangular fuzzy membership function.

Combining Equation (6) with the geometric relationship in FIG. 1, parameters of

$${\tilde{P}}_{i , t}^{dso , vg}$$

are sequentially expressed as

$${\underline{P}}_{i}^{dso , v g} , {P}_{i , t}^{dso , v g , c} and {\breve{\overline{{P}_{i}}}}^{dso , v g} ;$$

it is to be known from Equation (7) that a reactive power range of the virtual generator is directly related to the active power of the virtual generator; and since the active power of the virtual generator is characterized by the type-I triangular fuzzy membership function, a type-II triangular fuzzy membership function is used for the fuzzy modeling of the reactive power of the virtual generator, and the reactive power range characterized by Equation (7) and the fuzzy modeling of the active power of the virtual generator characterized by Equation (14) are integrated.

The main membership function of the type-II triangular fuzzy membership function for the reactive power of the virtual generator, which is characterized in such a form

$${\tilde{Q}}_{i , t}^{dso , vg} = 〈 [ {\underline{l}}^{v g , q} , {\overline{l}}^{v g , q} ] , {c}^{vg , q} , [ {\underline{r}}^{vg , q} , {\overline{r}}^{vg , q} ] 〉 ,$$

and can be expressed as follows after substituting the parameters:

$${\tilde{Q}}_{i , t}^{dso , vg} = ( [ {\breve{\overline{{P}_{i}}}}^{dso , vg} tan {\underline{φ}}_{i}^{dso , vg} , {\underline{P}}_{i}^{dso , vg} tan {\underline{φ}}_{i}^{dso , vg} ] , {Q}_{i , t}^{dso , vg , c} , [ {\underline{P}}_{i}^{dso , vg} tan {\overline{φ}}_{i}^{dso , vg} , {\breve{\overline{{P}_{i}}}}^{dso , vg} tan {\overline{φ}}_{i}^{dso , vg} ] 〉 \qquad ( 15 )$$

where

$${Q}_{i , t}^{dso , vg , c}$$

represents a reactive output value based on optimal decision;
due to the parameter magnitude relationship of the type-II triangular fuzzy membership function, corrected parameters are given as:

$${\breve{\overline{{P}_{i}}}}^{dso , vg} tan {\underline{φ}}_{i}^{dso , vg} , min ( {Q}_{i , t}^{dso , vg , c} , {\underline{P}}_{i}^{dso , vg} tan {\underline{φ}}_{i}^{dso , vg} ) , {Q}_{i , t}^{dso , vg , c} ,$$

$$max ( {Q}_{i , t}^{dso , vg , c} , {\underline{P}}_{i}^{dso , vg} tan {\overline{φ}}_{i}^{dso , vg} ) and {\breve{\overline{{P}_{i}}}}^{dso , vg} tan {\overline{φ}}_{i}^{dso , vg} ;$$

the corresponding upper membership function

$${v}_{\vec{Q}}^{dso , +}$$

and lower membership function

$${v}_{\tilde{Q}}^{dso , -}$$

are as follows:

$$\{ \begin{matrix}{v}_{\tilde{Q}}^{dso , +} = 〈 {\breve{\overline{{P}_{i}}}}^{dso , vg} tan {\underline{φ}}_{i}^{dso , vg} , {Q}_{i , t}^{dso , vg , c} , {\breve{\overline{{P}_{i}}}}^{dso , vg} tan {\overline{φ}}_{i}^{dso , vg} 〉 \\ {v}_{\tilde{Q}}^{dso , -} = 〈 \begin{matrix}min ( {Q}_{i , t}^{dso , c} , {\underline{P}}_{i}^{dso , vg} tan {\underline{φ}}_{i}^{dso , vg} ) , \\ {Q}_{i , t}^{dso , vg , c} , max ( {Q}_{i , t}^{dso , c} , {\underline{P}}_{i}^{dso , vg} tan {\overline{φ}}_{i}^{dso , vg} )\end{matrix} 〉\end{matrix} \qquad ( 16 )$$

the left endpoint l corresponding to

$${Q}_{i , t}^{dso , vg}$$

is the type-I triangular fuzzy membership function, with parameters:

$$( 17 )$$

$$〈 {\breve{\overline{{P}_{i}}}}^{dso , vg} tan {\underline{φ}}_{i}^{dso , vg} , min [ min ( {Q}_{i , t}^{dso , vg , c} , {\underline{P}}_{i}^{dso , vg} tan {\underline{φ}}_{i}^{dso , vg} ) , {P}_{i , t}^{dso , vg} tan {\underline{φ}}_{i}^{dso , vg} ] , min ( {Q}_{i , t}^{dso , vg ,} , {\underline{P}}_{i}^{dso , vg} tan {\underline{φ}}_{i}^{dso , vg} 〉$$

similarly, the corresponding right endpoint r has similar parameter characteristics, which are:

$$〈 max ( {Q}_{i , t}^{dso , vg , c} , {\underline{P}}_{i}^{dso , vg} tan {\overline{φ}}_{i}^{dso , vg} ) , max [ max ( {Q}_{i , t}^{dso , vg , c} , {\underline{P}}_{i}^{dso , vg} tan {\overline{φ}}_{i}^{dso , vg} ) , {P}_{i , t}^{dso , vg , c} tan {\overline{φ}}_{i}^{dso , vg} ] , {\breve{\overline{{P}_{i}}}}^{dso , vg} tan {\overline{φ}}_{i}^{dso , vg} 〉 \qquad ( 18 )$$

through setting rules of the fuzzy system, the type-II triangular fuzzy membership function for the reactive power of the virtual generator is obtained;
for

$${Q}_{i , t}^{dso , ve} ,$$

it is known from Equation (10) that

$${P}_{i , t}^{dso , ve}$$

is different from

$${P}_{i , t}^{dso , vg} ,$$

when modeling

$${Q}_{i , t}^{dso , ve} ,$$

a fuzzy model of virtual energy storage is established through the method of first establishing the type-I triangular fuzzy membership function for

$${P}_{i , t}^{dso , ve}$$

and establishing the type-II triangular fuzzy membership function for

$${Q}_{i , t}^{dso , ve} ,$$

following a completely opposite order, since

$${E}_{i , t}^{dso , ve}$$

is directly determined by

$${P}_{i , t}^{dso , ve} ,$$

and for the unification of

$${Q}_{i , t}^{dso , vg}$$

modeling format,

$${P}_{i , t}^{dso , ve}$$

is determined as a basic model of the type-I triangular fuzzy membership function;
the parameter values of

$${\tilde{P}}_{i , t}^{dso , ve}$$

are sequentially

$$min ( {\overline{P}}_{i}^{dso , ve} \cdot sign ( {P}_{i , t}^{dso , ve , c} ) , 0 ) , {P}_{i , t}^{dso , ve , c} and max ( {\overline{P}}_{i}^{dso , ve} \cdot sign ( {P}_{i , t}^{dso , ve , c} ) , 0 ) ;$$

the same method as that for the virtual generator is adopted for the fuzzy modeling of

$${Q}_{i , t}^{dso , ve} ,$$

the type-II triangular fuzzy membership function is

$${\tilde{Q}}_{i , t}^{dso , ve} = 〈 [ {\underline{l}}^{ve , q} , {\overline{l}}^{ve , q} ] , {c}^{ve , q} , [ {\underline{r}}^{ve , q} , {\overline{r}}^{ve , q} ] 〉 ,$$

and Equation (10) and N_{dso} decisions

$${Q}_{i , t}^{dso , ve , c}$$

are substituted into the main membership function as follows:

$$〈 [ - {\overline{Q}}_{i , t}^{dso , ve} , min ( {Q}_{i , t}^{dso , ve , c} , 0 ) ] , {Q}_{i , t}^{dso , ve , c} , [ max ( {Q}_{i , t}^{dso , ve , c} , 0 ) , {\overline{Q}}_{i , t}^{dso , ve} ] 〉 \qquad ( 19 )$$

the corresponding upper membership function

$${v}_{\tilde{Q}}^{vpp , +}$$

and lower membership function

$${v}_{\tilde{Q}}^{vpp , -}$$

are as follows:

$$\{ \begin{matrix}{v}_{\tilde{Q}}^{vpp , +} = 〈 - {\overline{Q}}_{i , t}^{dso , ve} , {Q}_{i , t}^{dso , ve , c} , {\overline{Q}}_{i , t}^{dso , ve} 〉 \\ {v}_{\tilde{Q}}^{vpp , -} = 〈 min ( {Q}_{i , t}^{dso , ve , c} , 0 ) , {Q}_{i , t}^{dso , ve , c} , max ( {Q}_{i , t}^{dso , ve , c} , 0 ) 〉\end{matrix} \qquad ( 20 )$$

membership functions of l and r are as follows:

$$\{ \begin{matrix}l = 〈 - {\overline{Q}}_{i , t}^{dso , ve} , - {Q}_{i , t}^{dso , P , c} , min ( {Q}_{i , t}^{dso , ve , c} , 0 ) 〉 \\ r = 〈 max ( {Q}_{i , t}^{dso , ve , c} , 0 ) , {Q}_{i , t}^{dso , P , c} , {\overline{Q}}_{i , t}^{dso , ve} 〉\end{matrix} \qquad ( 21 )$$

where

$${Q}_{i , t}^{dso , P , c} = \sqrt{{( {S}_{i}^{dso , we} )}^{2} - {( {P}_{i , t}^{dso , ve , c} )}^{2}} ,$$

the complete fuzzy modeling of N_{dso} is obtained; combined with the modeling of Nₙₒᵣ, the fuzzy form of the dynamic security space of the DN is obtained as follows:

$${\sum }_{j = 1}^{n} γ {\tilde{P}}_{j} + χ {\tilde{Q}}_{j} \leq 1 \qquad ( 22 )$$

Equation (22) including fuzzy and random factors is expressed in the form of a credibility chance constraint as follows:

$$Ch \{ {\sum }_{j = 1}^{n} γ {P}_{j} + χ {Q}_{j} \leq 1 \} \geq α \qquad ( 23 )$$

where Ch represents a chance measure, and α represents a credibility;
for the random factors in N_{dso} and Nₙₒᵣ, derandomization is performed through the probability confidence level, and Equation (23) is equivalent to:

$$Cr \{ w ∈ Ω \vert Pr \{ {\sum }_{j = 1}^{n} γ {P}_{j} + χ {Q}_{j} \leq 1 \} \geq {α}^{*} \} \geq α \qquad ( 24 )$$

where Cr represents a credibility measure, Pr represents a probability measure, and α* represents a confidence level;
it is converted into:

$$Cr \{ ( {P}^{⌣} , {Q}^{⌣} ) = {C}_{DF , dso , nor}^{- 1} ( {α}^{*} ) \vert {\sum }_{j = 1}^{N} γ {P}_{j} + χ {Q}_{j} \leq 1 \} \geq α \qquad ( 25 )$$

where

$${C}_{DF , dso , nor}^{- 1}$$

represents an inverse function of a cumulative distribution function.

Through the deterministic conversion of random variables characterizing output and parameters within the model, a fuzzy chance constraint model of the dynamic security space of the DN including the type-I triangular fuzzy membership function and type-II triangular fuzzy membership function is established.

Through the deterministic conversion of random variables characterizing output and parameters within the model, a fuzzy chance constraint model of the dynamic security space of the DN including the type-I triangular fuzzy membership function and type-II triangular fuzzy membership function is established. Although the dynamic security space of the DN has been expressed by Equation (25), it cannot be directly applied to the calculation of the aggregation regulation capability of the VPP. This is caused by the fact that the dynamic security space of the DN includes the type-II triangular fuzzy membership function, which makes it impossible to directly convert the chance constraint including Q into a clear equivalent form. Type reduction needs to be performed on the fuzzy model of Q. The credibility chance constraint is transformed into a clear equivalent form under a specific confidence level through model type reduction, and the dynamic security space of the DN provided by the DN operator to the VPP can be directly applied.

On the basis of the centroid type reduction based on α-cut, this paper adopts an advanced improved enhanced opposite-direction search algorithm to perform type reduction on the type-II triangular fuzzy membership function. Furthermore, combined with the generalized credibility measure theory, an equivalent method for the credibility chance constraint of the dynamic security space of the DN characterized by the piecewise membership function is proposed.

For the type-II triangular fuzzy membership function in the dynamic security space of the DN, the left endpoint

$${C}_{α}^{L}$$

of the centroid set of the α-plane of the type-II triangular fuzzy membership function is defined, sampling points qₗ_{_{α}} of the α-plane where l_{α}∈{k|1≤k≤N} are inevitably present such that

$${q}_{{l}_{α}} \leq {C}_{α}^{L} \leq {q}_{{l}_{α} + 1} ,$$

and the following equation is obtained by further combining equations (16) and (20):

$$\{ \begin{matrix}{\sum }_{i = 1}^{{l}_{α} - 1} ( {q}_{{l}_{α}} - {q}_{i} ) \cdot {v}_{\tilde{Q}}^{+} ( {q}_{i} \vert α ) \leq {\sum }_{i = {l}_{α} + 1}^{N} ( {q}_{i} - {q}_{{l}_{α}} ) \cdot {v}_{\tilde{Q}}^{-} ( {q}_{i} \vert α ) \\ {\sum }_{i = 1}^{{l}_{α}} ( {q}_{{l}_{α} + 1} - {q}_{i} ) \cdot {v}_{\tilde{Q}}^{+} ( {q}_{i} \vert α ) \leq {\sum }_{i = {l}_{α} + 2}^{N} ( {q}_{i} - {q}_{{l}_{α} + 1} ) \cdot {v}_{\tilde{Q}}^{-} ( {q}_{i} \vert α )\end{matrix} \qquad ( 26 )$$

a function

$${h}_{\tilde{Q}}^{α}$$

is defined as follows:

$${h}_{\tilde{Q}}^{α} ( k ) = {\sum }_{i = k + 1}^{N} ( {q}_{i} - {q}_{k} ) \cdot {v}_{\tilde{Q}}^{-} ( {q}_{i} \vert α ) - {\sum }_{i = 1}^{k - 1} ( {q}_{k} - {q}_{i} ) \cdot {v}_{\tilde{Q}}^{+} ( {q}_{i} \vert α ) \qquad ( 27 )$$

the vertical difference v_{\tilde{Q}}⁺(qᵢ|α)−v_{\tilde{Q}}⁻(qᵢ|α) between the upper membership function v_{\tilde{Q}}⁺ and the lower membership function v_{\tilde{Q}}⁻ on the α-plane is designated as v_{\tilde{Q}}(qᵢ|α), and is simultaneously defined as:

$${l}_{q , α} = {\sum }_{i = 1}^{N} {q}_{i} \cdot {v}_{\tilde{Q}}^{-} ( {q}_{i} \vert α ) , {l}_{α} = {\sum }_{i = 1}^{N} {v}_{\tilde{Q}}^{-} ( {q}_{i} \vert α ) \qquad ( 28 )$$

Equation (27) is expressed as:

$${h}_{\tilde{Q}}^{α} ( k ) = {l}_{q , α} - {q}_{k} {l}_{α} - {\sum }_{i = 1}^{k - 1} ( {q}_{k} - {q}_{i} ) \cdot {v}_{\tilde{Q}} ( {q}_{i} \vert α ) \qquad ( 29 )$$

by defining

$${δ}_{α} ( k ) = {l}_{α} + {\sum }_{i}^{k} {v}_{\tilde{Q}} ( {q}_{i} \vert α ) ,$$

the iterative equation is obtained as:

$${h}_{\tilde{Q}}^{α} ( k + 1 ) - {h}_{\tilde{Q}}^{α} ( k ) = ( {q}_{k} - {q}_{k + 1} ) {δ}_{α} ( k ) < 0 \qquad ( 30 )$$

the termination condition is to obtain the conversion point, based on the critical magnitude relationship of the conversion point, the termination condition is satisfied as follows:

$$\{ {h}_{\tilde{Q}}^{α} ( k ) < 0 \} and \{ {h}_{\tilde{Q}}^{α} ( k + 1 ) \geq 0 \} \qquad ( 31 )$$

at this point k=l_{α}, the left endpoint

$${C}_{α}^{L}$$

is derived as:

$${C}_{α}^{L} = {q}_{{l}_{α}} + {h}_{\tilde{Q}}^{α} ( {l}_{α} ) / {δ}_{P , α} ( {l}_{α} + 1 ) \qquad ( 32 )$$

by adopting the same approach, the right endpoint

$${C}_{α}^{R}$$

is expressed as when k=r_{α}:

$${C}_{α}^{R} = {q}_{{l}_{α}} + {h}_{\tilde{Q}}^{α} ( {r}_{α} ) / {δ}_{Q , α} ( {r}_{α} ) \qquad ( 33 )$$

Due to the unique correspondence between qᵢ and v_{\tilde{Q}}⁺(qᵢ|α) and v_{\tilde{Q}}⁻(qᵢ|α) of the type-II triangular fuzzy membership function, when α:0→1,

$${C}_{α}^{R} ↑ and {C}_{α}^{L} ↓ .$$

The conversion from the type-II triangular fuzzy membership function to the type-I triangular fuzzy membership function is achieved by utilizing the improved enhanced opposite direction search algorithm based on the characteristics of the type-II triangular fuzzy membership function.

After converting the type-II triangular fuzzy membership function of the dynamic security space of the DN into the type-I triangular fuzzy membership function by means of the improved enhanced opposite direction search algorithm, the unified form of all power fuzzy membership functions for virtual generators and virtual energy storage is given as follows:

$${ℒ}^{L , R} = {ℒ}^{L} ( {C}_{α}^{L} , {α}^{L} ) , {ℒ}^{R} ( {C}_{α}^{R} , {α}^{R} ) \qquad ( 34 )$$

[symbol] ^{L,R} represents a piecewise fuzzy membership function included by

$${ℒ}^{L} ( {C}_{α}^{L} , {α}^{L} ) and {ℒ}^{R} ( {C}_{α}^{R} , {α}^{R} ) , {ℒ}^{L} ( {C}_{α}^{L} , {α}^{L} ) and {ℒ}^{R} ( {C}_{α}^{R} , {α}^{R} )$$

represent piecewise fuzzy membership functions formed by the left endpoint, right endpoint and corresponding α under each α, each segment of the fuzzy membership function is abbreviated as [symbol] (C(α)). The further clarification equivalence of the dynamic security space of the DN characterized by Equation (23) is performed.

N_{dso} is separated from the dynamic security space of the DN, and Equation (23) is transformed into:

$$Cr \{ {\sum }_{j = 1}^{{J}_{dso}} γ {P}_{j}^{dso} + {\sum }_{j = 1}^{{J}_{dso}} χ {Q}_{j}^{dso} \leq κ \} \geq \text{?} \qquad ( 35 )$$

$$κ = 1 - {\sum }_{j = 1}^{{J}_{nor}} ( γ {\hat{P}}_{j}^{nor} + χ {\hat{Q}}_{j}^{nor} ) + {\sum }_{j = 1}^{{J}_{dso}} ( γ {P}_{j}^{vpp} + χ {Q}_{j}^{vpp} ) \qquad ( 36 )$$

where

$${P}_{j}^{dso} and {Q}_{j}^{dso}$$

represent compact forms of N_{dso}-controlled resources;

$${\hat{P}}_{j}^{nor} and {\hat{Q}}_{j}^{nor}$$

represent compact forms of Nₙₒᵣ-controlled resources;

$${P}_{j}^{vpp} and {Q}_{j}^{vpp}$$

represent compact forms of Nᵥₚₚ-controlled resources; and [symbol] represents the credibility;
the least common divisor interval of the multi-segment linear membership [symbol] function in Equation (34) is characterized as ( [symbol] ᵢ, [symbol] ᵢ+Δ [symbol] ), and within this interval, the credibility chance constraint is expressed as:

$$Cr \{ {\sum }_{j = 1}^{2 {J}_{dso}} {ϖ}_{i , j}^{s} {\text{?}}_{j} \leq κ \} \geq \text{?} , s ∈ \{ P , Q \} \qquad ( 37 )$$

where ℑⱼ represents a node power of N_{dso};

$${ϖ}_{i , j}^{s}$$

represents a hyperplane coefficient γ corresponding to the node j or a line ij (either or χ); and a piecewise clarification equivalence method based on the generalized credibility theory is proposed by taking confidence level [symbol] >0.5 as an example. Equation (37) is transformed into:

$$Cr \{ 𝔍 \leq κ \} = 0.5 ( 1 + {sup}_{x \leq κ} {μ}_{𝔍} ( x ) - {sup}_{x > κ} {μ}_{𝔍} ( x ) ) = 0.5 ( 1 + 1 - {sup}_{x > κ} {μ}_{𝔍} ( x ) ) \qquad ( 38 )$$

the following equivalent conversion of Cr{ℑ≤κ}≥ [symbol] is achieved:

$$Cr \{ 𝔍 \leq κ \} \geq 𝒫 ⇒ {sup}_{x > κ} {μ}_{𝔍} ( x ) \leq 2 - 2 𝒫 \qquad ( 39 )$$

for [symbol] ∈(0,1] and ℑₛᵤₚ( [symbol] )=sup{κ|sup_{x>k}μ_{ℑ}(x)≥ [symbol] }, there is ℑₛᵤₚ(2−2 [symbol] )≤κ.

By further combining Equation (37), the following equation is obtained:

$${𝔍}_{sup} ( 2 - 2 𝒫 ) = {( {\sum }_{j = 1}^{2 {J}_{dso}} {ϖ}_{i , j}^{s} {𝔍}_{j} )}_{sup} ( 2 - 2 𝒫 ) = {\sum }_{j = 1}^{2 n} {ϖ}_{i , j}^{s} {𝔍}_{j} ( 2 - 2 𝒫 ) \leq κ \qquad ( 40 )$$

if [symbol] ∈((2− [symbol] ᵢ)/2, (2−( [symbol] ᵢ+Δ [symbol] ))/2], for each i, there is:

$${ℒ}_{x} ( {C}^{R} ( {𝒫}_{i} ) ) = 2 - 2 𝒫 \qquad ( 41 )$$

by combining Equation (40), the following equation is obtained:

$${𝔍}_{sup} ( 2 - 2 𝒫 ) = {ℒ}_{x}^{- 1} ( 2 - 2 𝒫 ) .$$

where

$${ℒ}_{x}^{- 1} ( 2 - 2 𝒫 )$$

is a solution of Equation (41).

When [symbol] ∈(0.5,1]∩((2− [symbol] ᵢ)/2, (2−( [symbol] ᵢ+Δ [symbol] ))/2], Equation (37) is transformed into:

$${\sum }_{j = 1}^{{J}_{dso}} {ℒ}_{R , x , s , i}^{- 1} ( 2 - 2 𝒫 ) \leq κ , ∀ i ∈ {N}_{d} , s ∈ \{ P , Q \} \qquad ( 42 )$$

in the same way, when [symbol] ∈(0,0.5]∩( [symbol] ᵢ/2, ( [symbol] ᵢ+Δ [symbol] )/2], there is:

$${\sum }_{j = 1}^{{J}_{dso}} {ℒ}_{R , x , s , i}^{- 1} ( 2 𝒫 ) \leq κ , ∀ i ∈ {N}_{d} , s ∈ \{ P , Q \} \qquad ( 43 )$$

Therefore, the clear characterization of the dynamic security space of the DN based on credibility measures is achieved, and the VPP is enabled to directly apply the dynamic security space of the DN for the calculation of aggregation regulation capability through this series of transformation operations.

In S103: the dynamic security space of the DN is input into the pre-established aggregation model of the VPP, and the congestion capacity of the VPP is output as the solution result of the dynamic security space of the DN.

Since the dynamic security space of the DN is evolved from the SR of the DN, the number of constraint conditions in the dynamic security space of the DN is consistent with the number of network nodes. The reduction of the number of DN nodes is achieved through the above work. To achieve a more thorough concealment of network topology information, the redundant constraints of the dynamic security space of the DN can be identified and eliminated by means of the umbrella constraint identification method. The dynamic security space of the DN can realize the security guarantee within the resource scope covered by the VPP. Subsequently, the calculation of the aggregation capability of the VPP is performed based on the dynamic security space of the DN.

Virtual generators and virtual energy storage are also included in the VPP. The dynamic security space of the DN model based on credibility levels established in this paper is selected for network topology and power flow limits. The models of virtual generators and virtual energy storage are consistent with those of N_{dso}. The VPP aggregation model can be expressed as:

$${[ eq ( 6 ) - eq ( 10 ) ) ]}_{vpp} \qquad ( 44 )$$

$$[ {P}_{i , t}^{vpp} , {Q}_{i , t}^{vpp} ] ∈ {Ω}_{dsor} \qquad ( 45 )$$

$${P}_{t}^{vpp} = {\sum }_{i = 1}^{N} {P}_{i , t}^{vpp} , {Q}_{t}^{vpp} = {\sum }_{i = 1}^{N} {Q}_{i , t}^{vpp} \qquad ( 46 )$$

where [eq(6)-eq(10)]ᵥₚₚ represents the resource model of the VPP obtained by changing subscripts in Equations (6) to (10) to “vpp”;

$${P}_{i , t}^{vpp} and {Q}_{i , t}^{vpp}$$

represent the active power and reactive power of the resources in the VPP; Ω_{dsor} represents the dynamic security space of the DN; and

$${P}_{t}^{vpp} and {Q}_{t}^{vpp}$$

represent the active power and reactive power of the VPP.

Since the dynamic security space of the DN is characterized by hyperplanes, it can be concluded that all constraint conditions in the VPP model are linear constraint conditions. All faces of the polyhedron in the high-dimensional space characterized by the VPP model are planes. Therefore, the operation region of the VPP is projected as a polygon with a finite number of edges. The basic idea of the vertex enumeration method is that the vertices of the projected polygon are obtained through point-by-point solution by a series of optimization problems with different direction functions, and the polygon projection of the feasible region is given through convex hull approximation solution. The vertices of the projection of the VPP operation region are solved through optimization problems, and the optimization problem M2 is expressed as follows:

$${max}_{P , Q} {μ}_{h} \cdot {[ {P}_{h , t}^{vfrp} , {Q}_{h , t}^{vfrp} ]}^{T} \qquad ( 47 )$$

$$s . t . eq ( 64 ) - ( 65 ) , {Q}_{t}^{vfrp} = {P}_{t}^{vfrp} tan {φ}_{h} \qquad ( 48 )$$

where the direction vector μₕ is [cos φₕ, sin φₕ]; φₕ∈[0,2π];

$${P}_{t}^{vfrp} and {Q}_{t}^{vfrp}$$

represent the active power and reactive power within the projection plane.

Since the dynamic security space of the DN is involved, the boundary of the aggregation regulation capability of the VPP is likely to be affected. In the P-Q two-dimensional plane, this is mainly reflected in the reduction of the aggregated active power and reactive power of the VPP, and the projected area of the VPP operation region is also reduced accordingly. The concept of VPP congestion capacity is proposed in this paper to quantify the impact of the dynamic security space of the DN on the aggregation regulation capability of the VPP.

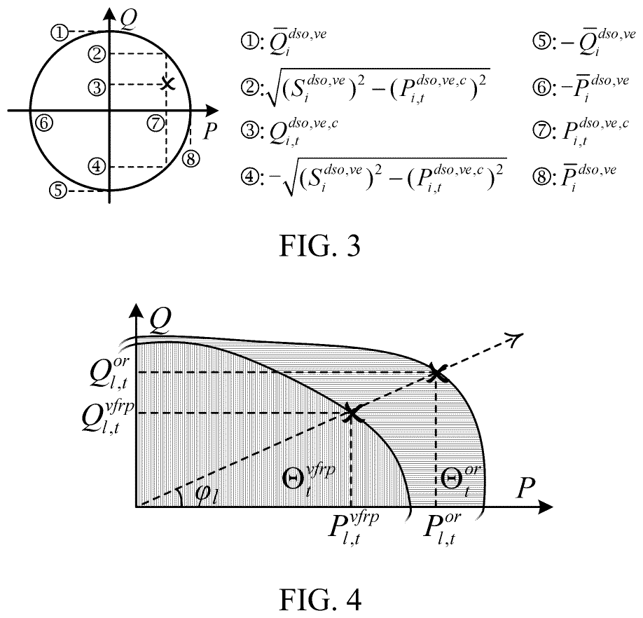

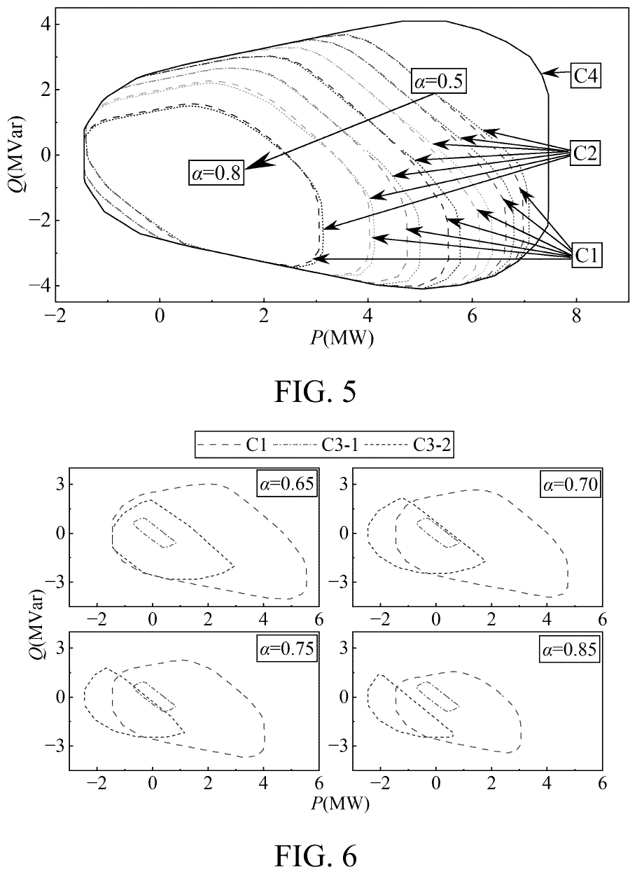

FIG. 3 shows a congestion diagram under a certain direction vector μₗ. The blue part represents the projection of the original VPP operation region, and the purple part represents the projection of the VPP operation region with the dynamic security space of the DN taken into account. This paper first quantifies the relative reduction of active power and reactive power after the dynamic security space of the DN is added under different power factors, and further quantifies the relative reduction of area after the addition of the dynamic security space of the DN. A calculation equation of the congestion capacity of the VPP is as follows:

$${γ}_{t} = {ω}_{1} \frac{1}{{N}_{h}} {\sum }_{i = 1}^{{N}_{h}} \sqrt{\frac{{( {P}_{h , t}^{or} - {P}_{h , t}^{vfrp} )}^{2} + {( {Q}_{h , t}^{or} - {Q}_{h , t}^{vfrp} )}^{2}}{{( {P}_{h , t}^{or} )}^{2} + {( {Q}_{h , t}^{or} )}^{2}}} + ( 1 - {ω}_{1} ) ( 1 - {Θ}_{t}^{vfrp} / {Θ}_{t}^{or} ) \qquad ( 49 )$$

where ω₁ represents an adjustment coefficient;

$${P}_{h , i}^{or} and {Q}_{h , i}^{or}$$

represent power operating points without considering the dynamic security space of the DN; and

$${Θ}_{t}^{vfrp} and {Θ}_{t}^{or}$$

represent projection areas considering and without considering the dynamic security space of the DN.

A day-ahead VPP congestion capacity is comprehensively evaluated by the maximum congestion [symbol] ^{max} and average congestion [symbol] ^{are}:

$${\text{?}}^{ave} = ( {\sum }_{t = 1}^{T} {Υ}_{t} ) / T , {Υ}^{max} = {max}_{t ∈ [ 1 , T ]} ( {Υ}_{t} ) \qquad ( 50 )$$

Example 2: to verify the effect of the method and system proposed in this disclosure, the settings of the actual verification case are given as follows: the internal topology of the selected VPP case is the IEEE-33 bus system; the current limit is set to 0.6 kA; the upper and lower limits of voltage are set to 12.66×1.05 kV and 12.66×0.95 kV; the confidence level of the random variables in the optimization problem M1 is set to 0.95; and the credibility of the fuzzy model is set to 0.85. In the type reduction of the TT2FS for virtual generators and virtual energy storage, the value of α-cut is set to N_{α}=1000. In the aggregation solution of the VPP, the number of direction vectors is set to 100×2π/8≈79. Control groups are set as follows:
C1: the projection of the feasible region of the VPP is calculated by means of the method and system proposed in this disclosure.
C2: complete power flow network constraints are imposed on the VPP by the DN.
C3-1: the operation envelope with all nodes in the DN decoupled is considered. C3-2: only the power relationship between the aggregated distributed resources is decoupled, and the operation envelopes thereof are calculated.
C4: the power flow network constraints are completely igₙₒᵣed.
C5: the operation mode of the distribution system is changed by modifying the objective function (5) and the grid switch combinations. C5-1 to C5-3: the grid topology structure is changed only by adjusting the connection status of the DN tie lines and the switches in the basic network topology. C5-4 and C5-5: only the objective function is modified.

As shown in FIG. 6, with the increase in credibility level, the constraints of the dynamic security space of the DN are tightened, which further leads to a reduction in the aggregation capacity of the VPP. In other words, the high reliability of the distribution system implies an improvement in security, which needs to be achieved by reducing the aggregation capacity of the VPP. Conversely, with the decrease in credibility level, the constraints of the dynamic security space of the DN are relaxed. The projection of the VPP operation region constrained by the dynamic security space of the DN gradually expands. A higher aggregation capacity of the VPP implies a higher security risk of the distribution system. This means that the boundary of the VPP aggregation capacity becomes more aggressive. Credibility reflects the current operation risk of the distribution system. This risk mainly stems from the uncertainty of the output power of all distributed resources in the distribution system. The DN needs to control the security risk of the power grid through credibility.

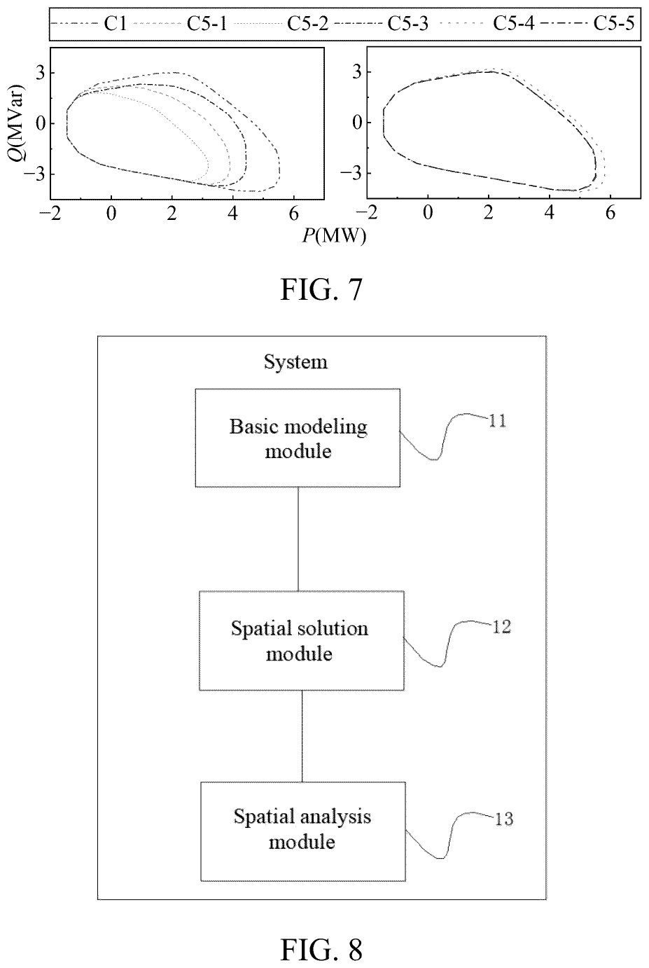

It can be seen from FIG. 7 that with the increase in credibility level, the boundary of the projection of the VPP operation region becomes increasingly smaller, and the overall position of the projection of the VPP operation region also changes accordingly. This is because as the confidence level increases, the operation envelope of each distributed resource in the VPP becomes narrower, resulting in a situation where the adjustable boundary of the virtual generators in Nᵥₚₚ has no intersection with the operation envelope. When the credibility level reaches 0.7, the virtual generators in Nᵥₚₚ have to maintain a minimal or even zero power output to satisfy the operation envelope requirements. At this time, the power support within the projection of the VPP operation region is mainly provided by virtual energy storage.

It can be seen from FIG. 8 that the DN exerts a significant impact on the projection of the VPP operation region by changing the operation mode of the DN. This also reflects indirectly that the operation mode of some nodes in the distribution system has a tremendous impact on other nodes. The operation envelope that achieves power decoupling between nodes sacrifices the power adjustable capability of distributed resources and exhibits strong conservatism. Different grid switch combinations and DN operation strategies both exert an influence on the dynamic security space of the DN and the projection of the VPP operation region. Therefore, the VPP congestion capacity can be applied to the interest coordination between the VPP and the DN. The DN can calculate the dynamic security space of the DN under various feasible day-ahead operation modes and provide all such dynamic security spaces of the DN to the VPP. The VPP calculates the projection of the operation region under all the dynamic security space of the DNs, selects the most reasonable dynamic security space of the DN by balancing the regulation cost and expected profit of the VPP congestion capacity to achieve the maximum profit. The DN restricts the VPP to aggregate within the security boundary by virtue of the dynamic security space of the DN to ensure the security of the distribution system. This is a win-win situation for the VPP and the DN.

Example 3: in a second aspect, as shown in FIG. 8, the present disclosure provides a system for solving dynamic security space of the DN aggregated by VPPs, including:
a basic modeling module 11, configured to acquire DN topology information and calculate a hyperplane-characterized SR of a DN based on the DN topology information; and acquire fuzzy resource boundaries uploaded by a VPP, perform optimal decision-making calculations based on the fuzzy resource boundaries, and establish a fuzzy model of DN resources using optimal decision values;
a spatial solution module 12, configured to input the fuzzy model of DN resources into the hyperplane-characterized SR of the DN to output a fuzzy dynamic security space of the DN; and perform type reduction and defuzzification on the fuzzy dynamic security space of the DN by an improved enhanced opposite direction search algorithm to obtain a dynamic security space of the DN; and
a spatial analysis module 13, configured to input the dynamic security space of the DN into a pre-established VPP aggregation model to output a VPP aggregation capacity; and calculate a VPP congestion capacity caused by the dynamic security space of the DN in combination with an original VPP aggregation capacity.

Based on the same inventive concept, the present disclosure also provides a computer device, including one or more processors, and a memory for storing one or more computer programs; and the program includes program instructions, and the processor is configured to execute the program instructions stored in the memory. The processor may be a central processing unit (CPU) or other general-purpose processor, a digital signal processor (DSP), an application specific integrated circuit (ASIC), a field-programmable gate array (FPGA) or other programmable logic device, a discrete gate or transistor logic device, a discrete hardware component, or the like, which is a computing core and a control core of the terminal for implementing one or more instructions, specifically for loading and executing one or more instructions in a computer storage medium to implement the above method.

It is to be further described that, based on the same inventive concept, the present disclosure further provides a computer storage medium. A computer program is stored on the storage medium, and the computer program, when executed by a processor, performs the above method. The storage medium may employ any combination of one or more computer readable media. The computer readable medium may be a computer readable signal medium or a computer readable storage medium. The computer-readable storage medium may be, for example, but is not limited to, an electrical, magnetic, optical, electrical, magnetic, infrared, or semiconductor system, apparatus, or device, or a combination of any of the above. More specific examples (a non-exhaustive list) of computer readable storage media include an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer readable storage medium may be any tangible medium including or storing a program that may be used by or in conjunction with an instruction execution system, apparatus, or device.

In the description of the specification, a description with reference to the terms “one example,” “instance,” “specific instance,” or the like means that a specific feature, structure, material, or characteristic described in connection with the example or instance is included in at least one example or instance of the present disclosure. In this specification, schematic representations of the above terms do not necessarily refer to the same example or instance. Furthermore, the specific features, structures, materials, or characteristics described may be combined in any suitable manner in any one or more examples or instances.

The basic principles, main features, and advantages of the present disclosure are shown and described above. It is to be understood by those skilled in the art that the present disclosure is not limited by the above examples, the above examples and the specification only illustrate the principles of the present disclosure, and various changes and improvements can be made to the present disclosure without departing from the spirit and scope of the present disclosure, and these changes and improvements fall within the scope of the present disclosure.

1. A method for solving dynamic security space of distribution networks (DNs) aggregated by virtual power plants (VPPs), comprising the steps of:
acquiring DN topology information and calculating a hyperplane-characterized security region (SR) of a DN based on the DN topology information; and acquiring fuzzy resource boundaries uploaded by a VPP, performing optimal decision-making calculations based on the fuzzy resource boundaries, and generating a fuzzy model of DN resources using optimal decision values;
inputting the fuzzy model of DN resources into the hyperplane-characterized SR of the DN to output a fuzzy dynamic security space of the DN; and performing type reduction and defuzzification on the fuzzy dynamic security space of the DN by an improved enhanced opposite direction search algorithm to obtain a dynamic security space of the DN; and
inputting the dynamic security space of the DN into a pre-established VPP aggregation model to output a VPP aggregation capacity; and calculating a VPP congestion capacity caused by the dynamic security space of the DN in combination with an original VPP aggregation capacity.

2. The method for solving dynamic security space of DNs aggregated by VPPs according to claim 1, wherein the SR of the DN describes power flow security constraints from the perspective of the region, the power flow security constraints comprise voltage constraint limits of all nodes and current constraint limits of all branches, and the SR of the DN with node injection power as a decision space is expressed by the following equations:
$${Ω}_{j}^{DVSR} = \{ {\sum }_{h = 1}^{n} {γ}_{j , h}^{U , M} {P}_{h} + {𝒳}_{j , h}^{U , M} {Q}_{h} \leq 1 , {\sum }_{h = 1}^{n} {γ}_{j , h}^{U , M} {P}_{h} + {𝒳}_{j , h}^{U , M} {Q}_{h} \leq 1 \} \qquad ( 1 )$$
$${Ω}_{i}^{DTSR} = \{ - 1 \leq {\sum }_{h = 1}^{n} {γ}_{i , h}^{I} {P}_{h} + {𝒳}_{i , h}^{I} {Q}_{h} \leq 1 \} \qquad ( 2 )$$
$${Ω}_{DSR} = {Ω}_{j}^{DVSR} ⋂ {Ω}_{i}^{DTSR} \qquad ( 3 )$$
where
$${Ω}_{j}^{DVSR}$$
represents a voltage SR of a node j;
$${γ}_{j , h}^{U , M} and {𝒳}_{j , h}^{U , M}$$
represent hyperplane coefficients of a node h in an upper voltage SR of the node j;
$${γ}_{j , h}^{U , M} and {𝒳}_{j , h}^{U , M}$$
represent hyperplane coefficients of the node h in the upper voltage SR of the node j; Pₕ and Qₕ represent an active and a reactive power injected by the node h;
$${Ω}_{i}^{D T S R}$$
represents a thermal stability SR of a line i;
$${γ}_{i , h}^{I} and {𝒳}_{i , h}^{I}$$
are hyperplane coefficients of the node h in the thermal stability SR of the line i; and Ω_{DSR} represents a hyperplane SR;
relevant hyperplane coefficients are corrected based on actual power flow operation results of DistFlow, and a compact form of the SR of the DN is given as follows:
$${\sum }_{j = 1}^{n} γ {P}_{j} + {𝒳Q}_{j} \leq 1 \qquad ( 4 )$$
where γ and χ represent the compact form of hyperplane coefficients; and Pⱼ and Qⱼ represent the compact form of node injection power.

3. The method for solving dynamic security space of DNs aggregated by VPPs according to claim 2, wherein set optimization objectives of the DN comprise the minimum global network loss and the minimum voltage deviation of the DN, and a multi-objective optimization problem M1 is set as follows, where objective functions are as follows:
$${min}_{{P}_{dso}} \{ λ {\sum }_{l = 1}^{L} ( {P}_{l , t}^{loss} ) + ( 1 - λ ) {\sum }_{i = 1}^{J} ( \vert Δ {U}_{i , t}^{C} \vert ) \} \qquad ( 5 )$$
$${\underline{P}}_{i}^{dso , vg} \leq {P}_{i , t}^{dso , vg} \leq {{P}^{{\_}^{⌣}}}_{i}^{dso , vg} \qquad ( 6 )$$
$${P}_{i , t}^{dso , vg} tan {\underline{φ}}_{i}^{dso , vg} \leq {Q}_{i , t}^{dso , vg} \leq {P}_{i , t}^{dso , vg} tan {\overline{φ}}_{i}^{dso , vg} \qquad ( 7 )$$
$$- {\overline{P}}_{i}^{dso , ve} \leq {P}_{i , t}^{dso , ve} \leq {\overline{P}}_{i}^{dso , ve} , {\underline{E}}_{i}^{dso , ve} \leq {E}_{i , t}^{dso , ve} \leq {\overline{E}}_{i ,}^{dso , ve} \qquad ( 8 )$$
$${E}_{i , t + 1}^{dso , ve} = {α}_{i}^{dso , ve} {E}_{i , t}^{dso , ve} + {β}_{i}^{dso , ve} {P}_{i , t}^{dso , ve} , {E}_{i , T}^{dso , ve} = {E}_{i , 0}^{dso , ve} \qquad ( 9 )$$
$${( {P}_{i , t}^{dso , ve} )}^{2} + {( {Q}_{i , t}^{dso , ve} )}^{2} \leq {( {S}_{i}^{dso , ve} )}^{2} \qquad ( 10 )$$
$${P}_{i , t}^{vpp , f} , {Q}_{i , t}^{vpp , f} ∈ [ {\tilde{κ}}_{i , t}^{μ} , {\tilde{κ}}_{i , t}^{σ} ] ; {\tilde{κ}}_{i , t}^{μ} , {\tilde{κ}}_{i , t}^{σ} = 〈 a , b , c 〉 \qquad ( 11 )$$
$${P}_{i , t}^{nor} = {{P}^{⌣}}_{i , t}^{nor} , {Q}_{i , t}^{nor} = {{Q}^{⌣}}_{i , t}^{nor} \qquad ( 12 )$$
$${S}_{n} = F ( P , Q , U , I ) \qquad ( 13 )$$
where λ represents a multi-objective coefficient;
$${P}_{l , t}^{loss}$$
represents a network loss of a line l at a time t;
$$Δ {U}_{i , t}^{c}$$
represents a voltage deviation of the node i at the time t;
$${P}_{i , t}^{dso , vg} and {Q}_{i , t}^{dso , vg}$$
represent an active power and a reactive power of a virtual generator in N_{dso};
$${{P}^{{\_}^{⌣}}}_{i}^{dso , vg} and {\underline{P}}_{i}^{dso , vg}$$
represent upper and lower limits of the active power of the virtual generator in N_{dso};
$${\overline{φ}}_{i}^{dso , vg} and {\underline{φ}}_{i}^{dso , vg}$$
represent upper and lower limits of a power factor angle of the virtual generator in N_{dso};
$${P}_{i , t}^{dso , ve} and {Q}_{i , t}^{dso , ve}$$
represent an active power and a reactive power of virtual energy storage in N_{dso};
$${\overline{P}}_{i}^{dso , ve}$$
represents an active power limit of the virtual energy storage in N_{dso};
$${\overline{E}}_{i}^{dso , ve} and {\underline{E}}_{i}^{dso , ve}$$
represent energy limits of the virtual energy storage in N_{dso};
$${E}_{i , t}^{dso , ve}$$
represents an energy of the virtual energy storage in N_{dso};
$${S}_{i}^{dso , ve}$$
represents an apparent power limit of the virtual energy storage in N_{dso};
$${P}_{i , t}^{vpp , f} and {Q}_{i , t}^{vpp , f}$$
represent fuzzy output powers of all nodes provided by the VPP for Nᵥₚₚ;
$${\tilde{κ}}_{i , t}^{μ} and {\tilde{κ}}_{i , t}^{σ}$$
represent triangular fuzzy membership functions of upper and lower limits of the output power; α, b and c represent parameters of the triangular fuzzy membership functions;
$${P}_{i , t}^{nor} and {Q}_{i , t}^{nor}$$
represent an active power and a reactive power of Nₙₒᵣ; and Sₙ represents a power flow constraint; and
where (6)-(7) represent output constraints of the virtual generator in the nodes N_{dso} controlled by a DN operator; (8)-(9) represent output constraints of the virtual energy storage in N_{dso}; (11) represents fuzzy output boundary constraints of all node provided by the VPP for Nᵥₚₚ; (12) represents an output constraint of Nₙₒᵣ; (13) represents the DistFlow power flow constraint; and the optimization problem comprises random variables
$${{P}^{⌣}}_{i , t}^{nor} and {{Q}^{⌣}}_{i , t}^{nor} ,$$
and fuzzy variables
$${κ}_{i , t}^{μ} and {\tilde{κ}}_{i , t}^{σ} .$$

4. The method for solving dynamic security space of DNs aggregated by VPPs according to claim 1, wherein the performing optimal decision-making calculations based on the fuzzy resource boundaries comprises the steps of:
solving the multi-objective optimization problem M1 according to a specific operation mode to obtain operation results of N_{dso}, and modeling the resource output of N_{dso} nodes using a fuzzy model;
regarding N_{dso} decision values
$${P}_{i , t}^{dso , vg , c} , {Q}_{i , t}^{dso , vg , c} , {P}_{i , t}^{dso , ve , c} and {Q}_{i , t}^{dso , vg , c}$$
obtained by solving the optimization problem M1, serving as the most probable operation results under a specific DN operation state, performing separate fuzzy modeling for the active power and reactive power in N_{dso} nodes:
modeling an active power
$${\tilde{P}}_{i}^{dso}$$
of the virtual generator using a type-I triangular fuzzy membership function:
$$μ ( {\tilde{P}}_{i}^{dso} ) = \{ \begin{matrix}( {\tilde{P}}_{i}^{dso} - {F}_{1 , i}^{P} ) / ( {F}_{2 , i}^{P} - {F}_{1 , i}^{P} ) , & {\tilde{P}}_{i}^{dso} ∈ ( {F}_{1 , i}^{p} , {F}_{2 , i}^{p} ] \\ ( {F}_{3 , i}^{P} - {\tilde{P}}_{i}^{dso} ) / ( {F}_{3 , i}^{P} - {F}_{2 , i}^{P} ) & {\tilde{P}}_{i}^{dso} ∈ ( {F}_{2 , i}^{p} , {F}_{3 , i}^{p} ] \\ 0 , & other\end{matrix} \qquad ( 14 )$$
where
$${F}_{1 , i}^{p} , {F}_{2 , i}^{p} and {F}_{3 , i}^{p}$$
represent three parameters of the triangular fuzzy membership function; and
parameters of the active power
$${\tilde{P}}_{i , t}^{dso , vg}$$
of the virtual generator in N_{dso} are sequentially expressed as
$${\underline{P}}_{i}^{dso , vg} , {P}_{i , t}^{dso , vg , c} {{\overline{{P}_{i}}}^{⌣}}^{dso , vg} ;$$
it is to be known from Equation (7) that a reactive power range of the virtual generator is directly related to the active power of the virtual generator; and since the active power of the virtual generator is characterized by the type-I triangular fuzzy membership function, a type-II triangular fuzzy membership function is used for the fuzzy modeling of the reactive power of the virtual generator, and the reactive power range characterized by Equation (7) and the fuzzy modeling of the active power of the virtual generator characterized by Equation (14) are integrated;
obtaining a main membership function of the type-II triangular fuzzy membership function for the reactive power of the virtual generator, and substituting the parameters, the following expression is obtained:
$${\tilde{Q}}_{i , t}^{dso , vg} = 〈 [ {{\overline{{P}_{i}}}^{⌣}}^{dso , vg} tan {\underline{φ}}_{i}^{dso , vg} , {\underline{P}}_{i}^{dso , vg} tan {\underline{φ}}_{i}^{dso , vg} ] , {Q}_{i , t}^{dso , vg , c} , [ {\underline{P}}_{i}^{dso , vg} tan {\overline{φ}}_{i}^{dso , vg} , {{\overline{{P}_{i}}}^{⌣}}^{dso , vg} tan {\overline{φ}}_{i}^{dso , vg} ] 〉 \qquad ( 15 )$$
where
$${Q}_{i , t}^{dso , vg , c}$$
represents a reactive output value based on optimal decision;
due to the parameter magnitude relationship of the type-II triangular fuzzy membership function, corrected parameters are given as:
$${{\overline{{P}_{i}}}^{⌣}}^{dso , vg} tan {\underline{φ}}_{i}^{dso , vg} , min ( {Q}_{i , t}^{dso , vg , c} , {\underline{P}}_{i}^{dso , vg} tan {\underline{φ}}_{i}^{dso , vg} ) , {Q}_{i , t}^{dso , vg , c} , max ( {Q}_{i , t}^{dso , vg , c} , {\underline{P}}_{i}^{dso , vg} tan {\overline{φ}}_{i}^{dso , vg} ) and {{\overline{{P}_{i}}}^{⌣}}^{dso , vg} tan {\overline{φ}}_{i}^{dso , vg} ;$$
the corresponding upper membership function
$${v}_{\tilde{Q}}^{dso , +}$$
and lower membership function
$${v}_{\tilde{Q}}^{dso , -}$$
are as follows:
$$\{ \begin{matrix}{v}_{\tilde{Q}}^{dso , +} = 〈 {{\overline{{P}_{i}}}^{⌣}}^{dso , vg} tan {\underline{φ}}_{i}^{dso , vg} , {Q}_{i , t}^{dso , vg , c} , {{\overline{{P}_{i}}}^{⌣}}^{dso , vg} tan {\overline{φ}}_{i}^{dso , vg} 〉 \\ {v}_{\tilde{Q}}^{dso , -} = 〈 \begin{matrix}min ( {Q}_{i , t}^{dso , c} , {\underline{P}}_{i}^{dso , vg} tan {\underline{φ}}_{i}^{dso , vg} ) , \\ {Q}_{i , t}^{dso , vg , c} , max ( {Q}_{i , t}^{dso , c} , {\underline{P}}_{i}^{dso , vg} tan {\underline{φ}}_{i}^{dso , vg}\end{matrix} 〉\end{matrix} \qquad ( 16 )$$
the left endpoint l corresponding to
$${Q}_{i , t}^{dso , vg}$$
is the type-I triangular fuzzy membership function, with parameters:
$$〈 {{\overline{{P}_{i}}}^{⌣}}^{dso , vg} tan {\underline{φ}}_{i}^{dso , vg} , min [ min ( {Q}_{i , t}^{dso , vg , c} , {\underline{P}}_{i}^{dso , vg} tan {\underline{φ}}_{i}^{dso , vg} ) , {P}_{i , t}^{dso , vg} tan {\underline{φ}}_{i}^{dso , vg} ] , min ( {Q}_{i , t}^{dso , vg ,} , {\underline{P}}_{i}^{dso , vg} tan {\underline{φ}}_{i}^{dso , vg} 〉 \qquad ( 17 )$$
similarly, the corresponding right endpoint r has similar parameter characteristics, which are:
$$〈 max ( {Q}_{i , t}^{dso , vg , c} , {\underline{P}}_{i}^{dso , vg} tan {\overline{φ}}_{i}^{dso , vg} ) , max [ max ( {Q}_{i , t}^{dso , vg , c} , {\underline{P}}_{i}^{dso , vg} tan {\overline{φ}}_{i}^{dso , vg} ) , {P}_{i , t}^{dso , vg , c} tan {\overline{φ}}_{i}^{dso , vg} ] , {{\overline{{P}_{i}}}^{⌣}}^{dso , vg} tan {\overline{φ}}_{i}^{dso , vg} 〉 \qquad ( 18 )$$
through setting rules of the fuzzy system, the type-II triangular fuzzy membership function for the reactive power of the virtual generator is obtained;
for
$${Q}_{i , t}^{dso , ve} ,$$
it is known from Equation (10) that
$${P}_{i , t}^{dso , ve} ,$$
is different from
$${P}_{i , t}^{dso , vg} ,$$
when modeling
$${Q}_{i , t}^{dso , ve} ,$$
a fuzzy model of virtual energy storage is established through the method of first establishing the type-I triangular fuzzy membership function for
$${P}_{i , t}^{dso , ve}$$
and establishing the type-II triangular fuzzy membership function for
$${Q}_{i , t}^{dso , ve} ,$$
following a completely opposite order, since
$${E}_{i , t}^{dso , ve}$$
is directly determined by
$${P}_{i , t}^{dso , ve} ,$$
and for the unification of
$${Q}_{i , t}^{dso , vg}$$
modeling format,
$${P}_{i , t}^{dso , ve}$$
is determined as a basic model of the type-I triangular fuzzy membership function;
the parameter values of
$${\tilde{P}}_{i , t}^{dso , ve}$$
are sequentially
$$min ( {\overline{P}}_{i}^{dso , ve} \cdot sign ( {P}_{i , t}^{dso , ve , c} ) , 0 ) , {P}_{i , t}^{dso , ve , c} and max ( {\overline{P}}_{i}^{dso , ve} \cdot sign ( {P}_{i , t}^{dso , ve , c} ) , 0 ) ;$$
the same method as that for the virtual generator is adopted for the fuzzy modeling of
$${Q}_{i , t}^{dso , ve} ,$$
and Equation (10) and N_{dso} decisions
$${Q}_{i , t}^{dso , ve , c}$$
are substituted into the main membership function as follows:
$$〈 [ - {\overline{Q}}_{i , t}^{dso , ve} , min ( {Q}_{i , t}^{dso , ve , c} , 0 ) ] , {Q}_{i , t}^{dso , ve , c} , [ max ( {Q}_{i , t}^{dso , ve , c} , 0 ) , {\overline{Q}}_{i , t}^{dso , ve} ] 〉 \qquad ( 19 )$$
the corresponding upper membership function
$${v}_{\tilde{Q}}^{vpp , +}$$
and lower membership function
$${v}_{\tilde{Q}}^{vpp , -}$$
are as follows:
$$\{ \begin{matrix}{v}_{\tilde{Q}}^{vpp , +} = 〈 {\overline{Q}}_{i , t}^{dso , ve} , {Q}_{i , t}^{dso , ve , c} , {\overline{Q}}_{i , t}^{dso , ve} 〉 \\ {v}_{\tilde{Q}}^{vpp , -} = 〈 min ( {Q}_{i , t}^{dso , ve , c} , 0 ) , {Q}_{i , t}^{dso , ve , c} , max ( {Q}_{i , t}^{dso , ve , c} , 0 ) 〉\end{matrix} \qquad ( 20 )$$
membership functions of l and r are as follows:
$$\{ \begin{matrix}l = 〈 - {\overline{Q}}_{i , t}^{dso , ve} , - {Q}_{i , t}^{dso , P , c} , min ( {Q}_{i , t}^{dso , ve , c} , 0 ) 〉 \\ r = 〈 max ( {Q}_{i , t}^{dso , ve , c} , 0 ) , {Q}_{i , t}^{dso , P , c} , {\overline{Q}}_{i , t}^{dso , ve} 〉\end{matrix} \qquad ( 21 )$$
where
$${Q}_{i , t}^{dso , P , c} = \sqrt{{( {S}_{i}^{dso , we} )}^{2} - {( {P}_{i , t}^{dso , ve , c} )}^{2}} ,$$
the complete fuzzy modeling of N_{dso} is obtained; combined with the modeling of Nₙₒᵣ, the fuzzy form of the dynamic security space of the DN is obtained as follows:
$${\sum }_{j = 1}^{n} γ {\tilde{P}}_{j} + χ {\tilde{Q}}_{j} \leq 1 \qquad ( 22 )$$
where \tilde{P}ⱼ and \tilde{Q}ⱼ are the fuzzy compact forms of node injection power;
Equation (22) comprising fuzzy and random factors is expressed in the form of a credibility chance constraint as follows:
$$Ch \{ {\sum }_{j = 1}^{n} γ {P}_{j} + χ {Q}_{j} \leq 1 \} \geq α \qquad ( 23 )$$
where Ch represents a chance measure, and α represents a credibility;
for the random factors in N_{dso} and Nₙₒᵣ, derandomization is performed through the probability confidence level, and Equation (23) is equivalent to:
$$Cr \{ w ∈ Ω \vert Pr \{ {\sum }_{j = 1}^{n} γ {P}_{j} + χ {Q}_{j} \leq 1 \} \geq {α}^{*} \} \geq α \qquad ( 24 )$$
where Cr represents a credibility measure, Pr represents a probability measure, and α* represents a confidence level;
it is converted into:
$$Cr \{ ( \breve{P} , \breve{Q} ) = {C}_{DF , dso , nor}^{- 1} ( {α}^{*} ) \vert {\sum }_{j = 1}^{n} γ {P}_{j} + χ {Q}_{j} \leq 1 \} \geq α \qquad ( 25 )$$
where
$${C}_{DF , dso , nor}^{- 1}$$
represents an inverse function of a cumulative distribution function; and
through the deterministic conversion of random variables characterizing output and parameters within the model, a fuzzy chance constraint model of the dynamic security space of the DN comprising the type-I triangular fuzzy membership function and type-II triangular fuzzy membership function is established.

5. The method for solving dynamic security space of DNs aggregated by VPPs according to claim 1, wherein the performing type reduction on the fuzzy dynamic security space of the DN by an improved enhanced opposite direction search algorithm comprises the steps of:
for the type-II triangular fuzzy membership function in the dynamic security space of the DN, the left endpoint
$${C}_{α}^{L}$$
of the centroid set of the α-plane of the type-II triangular fuzzy membership function is defined, sampling points qₗ_{_{α}} of the α-plane where l_{α}∈{k|1≤k≤N} are inevitably present such that
$${q}_{{l}_{α}} \leq {C}_{α}^{L} \leq {q}_{{l}_{α} + 1} ,$$
and the following equation is obtained by further combining equations (16) and (20):
$$\{ \begin{matrix}{\sum }_{i = 1}^{{l}_{α} - 1} ( {q}_{{l}_{α}} - {q}_{i} ) \cdot {v}_{\tilde{Q}}^{+} ( {q}_{i} \vert α ) \leq {\sum }_{i = {l}_{α} + 1}^{N} ( {q}_{i} - {q}_{{l}_{α}} ) \cdot {v}_{\tilde{Q}}^{-} ( {q}_{i} \vert α ) \\ {\sum }_{i = 1}^{{l}_{α}} ( {q}_{{l}_{α} + 1} - {q}_{i} ) \cdot {v}_{\tilde{Q}}^{+} ( {q}_{i} \vert α ) \leq {\sum }_{i = {l}_{α} + 2}^{N} ( {q}_{i} - {q}_{{l}_{α} + 1} ) \cdot {v}_{\tilde{Q}}^{-} ( {q}_{i} \vert α )\end{matrix} \qquad ( 26 )$$
a function
$${h}_{\tilde{Q}}^{α}$$
is defined as follows:
$${h}_{\tilde{Q}}^{α} ( k ) = {\sum }_{i = k + 1}^{N} ( {q}_{i} - {q}_{k} ) \cdot {v}_{\tilde{Q}}^{-} ( {q}_{i} \vert α ) - {\sum }_{i = 1}^{k - 1} ( {q}_{k} - {q}_{i} ) \cdot {v}_{\tilde{Q}}^{+} ( {q}_{i} \vert α ) \qquad ( 27 )$$
the vertical difference v_{\tilde{Q}}⁺(qᵢ|α)−v_{\tilde{Q}}⁻(qᵢ|α) between the upper membership function v_{\tilde{Q}}⁺ and the lower membership function v_{\tilde{Q}}⁻ on the α-plane is designated as v_{\tilde{Q}}(qᵢ|α), and is simultaneously defined as:
$${l}_{q , α} = {\sum }_{i = 1}^{N} {q}_{i} \cdot {v}_{\tilde{Q}}^{-} ( {q}_{i} \vert α ) , {l}_{α} = {\sum }_{i = 1}^{N} {v}_{\tilde{Q}}^{-} ( {q}_{i} \vert α ) \qquad ( 28 )$$
Equation (27) is expressed as:
$${h}_{\tilde{Q}}^{α} ( k ) = {l}_{q , α} - {q}_{k} {l}_{α} - {\sum }_{i = 1}^{k - 1} ( {q}_{k} - {q}_{i} ) \cdot {v}_{\tilde{Q}} ( {q}_{i} \vert α ) \qquad ( 29 )$$
by defining
$${δ}_{α} ( k ) = {l}_{α} + {\sum }_{i}^{k} {v}_{\tilde{Q}} ( {q}_{i} \vert α ) ,$$
the iterative equation is obtained as:
$${h}_{\tilde{Q}}^{α} ( k + 1 ) - {h}_{\tilde{Q}}^{α} ( k ) = ( {q}_{k} - {q}_{k + 1} ) {δ}_{α} ( k ) < 0 \qquad ( 30 )$$
the termination condition is to obtain the conversion point, based on the critical magnitude relationship of the conversion point, the termination condition is satisfied as follows:
$$\{ {h}_{\tilde{Q}}^{α} ( k ) < 0 \} and \{ {h}_{\tilde{Q}}^{α} ( k + 1 ) \geq 0 \} \qquad ( 31 )$$
at this point k=l_{α}, the left endpoint
$${C}_{α}^{L}$$
is derived as:
$${C}_{α}^{L} = {q}_{{l}_{α}} + {h}_{\tilde{Q}}^{α} ( {l}_{α} ) / {δ}_{P , α} ( {l}_{α} + 1 ) \qquad ( 32 )$$
by adopting the same approach, the right endpoint
$${C}_{α}^{R}$$
is expressed as when k=r_{α}:
$${C}_{α}^{R} = {q}_{{l}_{α}} + {h}_{\tilde{Q}}^{α} ( {r}_{α} ) / {δ}_{Q , α} ( {r}_{α} ) \qquad ( 33 )$$
due to the unique correspondence between qᵢ and v_{\tilde{Q}}⁺(qᵢ|α) and v_{\tilde{Q}}⁻(qᵢ|α) of the type-II triangular fuzzy membership function, when α:0→1,
$${C}_{α}^{R} ↑ and {C}_{α}^{L} ↓ ,$$
the conversion from the type-II triangular fuzzy membership function to the type-I triangular fuzzy membership function is achieved by utilizing the improved enhanced opposite direction search algorithm based on the characteristics of the type-II triangular fuzzy membership function.

6. The method for solving dynamic security space of DNs aggregated by VPPs according to claim 5, wherein the performing defuzzification on the fuzzy dynamic security space of the DN comprises the steps of:
after converting the type-II triangular fuzzy membership function of the dynamic security space of the DN into the type-I triangular fuzzy membership function by means of the improved enhanced opposite direction search algorithm, the unified form of all power fuzzy membership functions for virtual generators and virtual energy storage is given as follows:
$${ℒ}^{L , R} = {ℒ}^{L} ( {C}_{α}^{L} , {α}^{L} ) , {ℒ}^{R} ( {C}_{α}^{R} , {α}^{R} ) \qquad ( 34 )$$ [symbol]
^{L,R} represents a piecewise fuzzy membership function comprised by
$${ℒ}^{L} ( {C}_{α}^{L} , {α}^{L} ) and {ℒ}^{R} ( {C}_{α}^{R} , {α}^{R} ) , {ℒ}^{L} ( {C}_{α}^{L} , {α}^{L} ) and {ℒ}^{R} ( {C}_{α}^{R} , {α}^{R} )$$
represent piecewise fuzzy membership functions formed by the left endpoint, right endpoint and corresponding α under each α, each segment of the fuzzy membership function is abbreviated as [symbol] (C(α)), and the further clarification equivalence of the dynamic security space of the DN characterized by Equation (23) is performed;
N_{dso} is separated from the dynamic security space of the DN, and Equation (23) is transformed into:
$$Cr \{ {\sum }_{j = 1}^{{J}_{dso}} γ {P}_{j}^{dso} + {\sum }_{j = 1}^{{J}_{dso}} χ {Q}_{j}^{dso} \leq κ \} \geq \text{?} \qquad ( 35 )$$
$$κ = 1 - {\sum }_{j = 1}^{{J}_{nor}} ( γ {\hat{P}}_{j}^{nor} + χ {\hat{Q}}_{j}^{nor} ) + {\sum }_{j = 1}^{{J}_{dso}} ( γ {P}_{j}^{vpp} + χ {Q}_{j}^{vpp} ) \qquad ( 36 )$$
where
$${P}_{j}^{dso} and {Q}_{j}^{dso}$$
represent compact forms of N_{dso}-controlled resources;
$${\hat{P}}_{j}^{nor} and {\hat{Q}}_{j}^{nor}$$
represent compact forms of Nₙₒᵣ-controlled resources;
$${P}_{j}^{vpp} and {Q}_{j}^{vpp}$$
represent compact forms of Nᵥₚₚ-controlled resources; and [symbol] represents the credibility;
the least common divisor interval of the multi-segment linear membership function in Equation (34) is characterized as ( [symbol] ᵢ, [symbol] ᵢ+Δ [symbol] ], and within this interval, the credibility chance constraint is expressed as:
$$Cr \{ {\sum }_{j = 1}^{2 {J}_{dso}} {ϖ}_{i , j}^{s} {\text{?}}_{j} \leq κ \} \geq \text{?} , s ∈ \{ P , Q \} \qquad ( 37 )$$
where ℑⱼ represents a node power of N_{dso};
$${ϖ}_{i , j}^{s}$$
represents a hyperplane coefficient γ corresponding to the node j or a line ij (either or χ); and Equation (37) is transformed into:
$$Cr \{ \text{?} \leq κ \} = 0.5 ( 1 + \text{?} ( x ) - \text{?} ( x ) ) = 0.5 ( 1 + 1 - \text{?} ( x ) ) \qquad ( 38 )$$
the following equivalent conversion of Cr{ℑ≤κ}≥ [symbol] is achieved:
$$Cr \{ \text{?} \leq κ \} \geq \text{?} ⇒ \text{?} ( x ) \leq 2 - 2 \text{?} \qquad ( 39 )$$
for [symbol] ∈(0,1] and ℑₛᵤₚ( [symbol] )=sup{κ|sup_{x>k}μ_{ℑ}(x)≥ [symbol] }, there is ℑₛᵤₚ(2−2 [symbol] )≤κ;
by further combining Equation (37), the following equation is obtained:
$${\text{?}}_{sup} ( 2 - 2 \text{?} ) = {( {\sum }_{j = 1}^{2 {J}_{dso}} {ϖ}_{i , j}^{s} {\text{?}}_{j} )}_{sup} ( 2 - 2 \text{?} ) = {\sum }_{j = 1}^{2 n} {ϖ}_{i , j}^{s} {\text{?}}_{j} ( 2 - 2 \text{?} ) \leq κ \qquad ( 40 )$$
if [symbol] ∈((2− [symbol] ᵢ)/2, (2−( [symbol] ᵢ+Δ [symbol] ))/2], for each I, there is:
$${ℒ}_{x} ( {C}^{R} ( {\text{?}}_{i} ) ) = 2 - 2 \text{?} \qquad ( 41 )$$
$${\text{?}}_{sup} ( 2 - 2 \text{?} ) = {ℒ}_{x}^{- 1} ( 2 - 2 \text{?} )$$
is obtained by combining Equation (40), where
$${ℒ}_{x}^{- 1} ( 2 - 2 \text{?} )$$
is a solution of Equation (41);
when [symbol] ∈(0.5,1]∩((2− [symbol] ᵢ)/2, (2−( [symbol] ᵢ+Δ [symbol] ))/2], Equation (37) is transformed into:
$${\sum }_{j = 1}^{{J}_{dso}} {ℒ}_{R , x , s , i}^{- 1} ( 2 - 2 \text{?} ) \leq κ , ∀ i ∈ {N}_{d} , s ∈ \{ P , Q \} \qquad ( 42 )$$
in the same way, when [symbol] ∈(0,0.5]∩( [symbol] ᵢ/2, ( [symbol] ᵢ+Δ [symbol] )/2], there is:
$${\sum }_{j = 1}^{{J}_{dso}} {ℒ}_{R , x , s , i}^{- 1} ( 2 \text{?} ) \leq κ , ∀ i ∈ {N}_{d} , s ∈ \{ P , Q \} \qquad ( 43 )$$
the fuzzy dynamic security space of the DN is defuzzified.

7. The method for solving dynamic security space of DNs aggregated by VPPs according to claim 1, wherein the pre-established VPP aggregation model is as follows:
$${[ eq ( 6 ) - eq ( 10 ) ]}_{vpp} \qquad ( 44 )$$
$$[ {P}_{i , t}^{vpp} , {Q}_{i , t}^{vpp} ] ∈ {Ω}_{dsor} \qquad ( 45 )$$
$${P}_{t}^{vpp} = {\sum }_{i = 1}^{N} {P}_{i , t}^{vpp} , {Q}_{t}^{vpp} = {\sum }_{i = 1}^{N} {Q}_{i , t}^{vpp} \qquad ( 46 )$$
where [eq(6)−eq(10)]ᵥₚₚ, represents the resource model of the VPP obtained by changing subscripts in Equations (6) to (10) to “vpp”;
$${P}_{i , t}^{vpp} and {Q}_{i , t}^{vpp}$$
represent the active power and reactive power of the resources in the VPP; Ω_{dsor} represents the dynamic security space of the DN; and
$${P}_{t}^{vpp} and {Q}_{t}^{vpp}$$
represent the active power and reactive power of the VPP;
all constraints in the VPP aggregation model are linear constraints, and all faces of the high-dimensional space polyhedron characterized by the VPP aggregation model are planes; and the vertices of the operation region projection of the VPP are solved by an optimization problem, and the optimization problem M2 is as follows:
$${max}_{P , Q} {μ}_{h} \cdot {[ {P}_{h , t}^{vfrp} , {Q}_{h , t}^{vfrp} ]}^{T} \qquad ( 47 )$$
$$s . t . eq ( 64 ) - ( 65 ) , {Q}_{t}^{vfrp} = {P}_{t}^{vfrp} tan {φ}_{h} \qquad ( 48 )$$
where the direction vector μₕ is [cos φₕ, sin φₕ]; φₕ ∈[0,2π];
$${P}_{t}^{vfrp} and {Q}_{t}^{vfrp}$$
represent the active power and reactive power within the projection plane;
a calculation equation of the congestion capacity Yₜ of the VPP is as follows:
$${\text{?}}_{t} = {ω}_{1} \frac{1}{{N}_{h}} {\sum }_{i = 1}^{{N}_{h}} \sqrt{\frac{{( {P}_{h , t}^{or} - {P}_{h , t}^{vfrp} )}^{2} + {( {Q}_{h , t}^{or} - {Q}_{h , t}^{vfrp} )}^{2}}{{( {P}_{h , t}^{or} )}^{2} + {( {Q}_{h , t}^{or} )}^{2}}} + ( 1 - {ω}_{1} ) ( 1 - {Θ}_{t}^{vfrp} / {Θ}_{t}^{or} ) \qquad ( 49 )$$
where ω₁ represents an adjustment coefficient;
$${P}_{h , i}^{or} and {Q}_{h , i}^{or}$$
represent power operating points without considering the dynamic security space of the DN; and
$${Θ}_{t}^{vfrp} and {Θ}_{t}^{or}$$
represent projection areas considering and without considering the dynamic security space of the DN;
a day-ahead VPP congestion capacity is comprehensively evaluated by the maximum congestion [symbol] ^{max} and average congestion [symbol] ^{are}:
$${\text{?}}^{ave} = ( {\sum }_{t = 1}^{T} {\text{?}}_{t} ) / T , {\text{?}}^{max} = {max}_{t ∈ [ 1 , T ]} ( {\text{?}}_{t} ) . \qquad ( 50 )$$

8. A system for solving dynamic security space of the DN aggregated by VPPs, comprising:
a basic modeling module, configured to acquire DN topology information and calculate a hyperplane-characterized SR of a DN based on the DN topology information; and acquire fuzzy resource boundaries uploaded by a VPP, perform optimal decision-making calculations based on the fuzzy resource boundaries, and establish a fuzzy model of DN resources using optimal decision values;
a spatial solution module, configured to input the fuzzy model of DN resources into the hyperplane-characterized SR of the DN to output a fuzzy dynamic security space of the DN; and perform type reduction and defuzzification on the fuzzy dynamic security space of the DN by an improved enhanced opposite direction search algorithm to obtain a dynamic security space of the DN; and
a spatial analysis module, configured to input the dynamic security space of the DN into a pre-established VPP aggregation model to output a VPP aggregation capacity; and calculate a VPP congestion capacity caused by the dynamic security space of the DN in combination with an original VPP aggregation capacity.

9. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 1 is adopted.

10. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 2 is adopted.

11. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 3 is adopted.

12. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 4 is adopted.

13. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 5 is adopted.

14. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 6 is adopted.

15. A terminal device, comprising a memory, a processor, and a computer program stored in the memory and capable of running on the processor, wherein the memory stores a computer program capable of running on the processor, and when the processor loads and executes the computer program, the method for solving dynamic security space of DNs aggregated by VPPs according to claim 7 is adopted.

16. A computer-readable storage medium, having a computer program stored therein, wherein when the computer program is loaded and executed by a processor, the method for solving dynamic security space of DNs aggregated by VPPs according to claim 1 is adopted.

17. A computer-readable storage medium, having a computer program stored therein, wherein when the computer program is loaded and executed by a processor, the method for solving dynamic security space of DNs aggregated by VPPs according to claim 2 is adopted.

18. A computer-readable storage medium, having a computer program stored therein, wherein when the computer program is loaded and executed by a processor, the method for solving dynamic security space of DNs aggregated by VPPs according to claim 3 is adopted.

19. A computer-readable storage medium, having a computer program stored therein, wherein when the computer program is loaded and executed by a processor, the method for solving dynamic security space of DNs aggregated by VPPs according to claim 4 is adopted.

20. A computer-readable storage medium, having a computer program stored therein, wherein when the computer program is loaded and executed by a processor, the method for solving dynamic security space of DNs aggregated by VPPs according to claim 5 is adopted.
